(19) United States
(12) Patent Application Publication
(10) Pub. No.: US 2005/0007404 A1
(43) Pub. Date: Jan. 13, 2005

(54) Printing apparatus comprising scanner and adjustment method therefor

(75) Inventor: Toshiki Usui, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/846,347

(22) Filed: May 14, 2004

(30) Foreign Application Priority Data
May 14, 2003 (JP) 2003-136552
May 12, 2004 (JP) 2004-142182

(51) Int. Cl. B41J 2/165; B41J 29/38; B41J 29/393

(52) U.S. Cl. 347/14; 347/17; 347/19; 347/23

(57) ABSTRACT

It is an object of the present invention to achieve a printing apparatus having a head driver for driving a head that ejects ink, a scanner for reading an image formed on a medium, and a controller for controlling the head driver to form a correction pattern on the medium, causing the scanner to read the correction pattern that has been formed on the medium, and correcting driving of the head by the head driver based on the results of reading the correction pattern.

### CROSS-REFERENCE TO RELATED APPLICATIONS

The present application claims priority upon Japanese Patent Application No. 2003-136552 filed on May 14, 2003 and Japanese Patent Application No.2004-142182 filed on May 12, 2004, which are herein incorporated by reference.

### BACKGROUND OF THE INVENTION

1. Field of the Invention

The present invention relates to printing apparatuses comprising scanners and adjustment methods therefor.

2. Description of the Related Art

Conventionally, printing apparatuses such as ink-jet printers have been widely used as output devices for computers. In inkjet printers, ink is ejected from nozzles by driving a head and the ink droplets that adhere to the paper form dots, thereby forming an image.

In such inkjet printers, the quality of the image that is printed drops when, for example, the amount of ink that is ejected from the head or the ejection timing is out of adjustment. For that reason it is preferable that the amount of ink that is ejected or the ejection timing, for example, is adjusted (for example, see Japanese Patent Application Examined Publication (Kohyo) No. 6-41205).

However, adjusting inkjet printers forces the user to perform bothersome tasks.

### SUMMARY OF THE INVENTION

It is an object of the present invention to reduce the amount of work that is performed by the user by using a printing apparatus provided with a scanner for reading images.

A printing apparatus of the present invention for achieving the foregoing object has a head driver for driving a head that ejects ink, a scanner for reading an image formed on a medium, and a controller for controlling the head driver to form a correction pattern on the medium, causing the scanner to read the correction pattern that has been formed on the medium, and correcting driving of the head by the head driver based on the results of reading the correction pattern.

Features and objects of the present invention other than the above will be made clear by the reading the present specification with reference to the accompanying drawings.

### BRIEF DESCRIPTION OF THE DRAWINGS

FIG. 1 is a perspective view that schematically shows the configuration of a recording apparatus according to the present embodiment.

FIG. 2 is a perspective view showing the appearance when the cover of the scanner section 10 is open.

FIG. 3 is an explanatory view showing the internal configuration of the recording apparatus.

FIG. 4 is a perspective view showing the exposed interior of the printer section.

FIG. 5 is a diagram showing an example of the control panel section.

FIG. 6 is an explanatory diagram showing the arrangement around the print head.

FIG. 7 is an explanatory diagram for describing the drive section of the print paper carry mechanism.

FIG. 8 is an explanatory diagram showing the arrangement of the nozzles in the lower surface 381 of the print head 38.

FIG. 9 is an explanatory diagram of the head unit 38.

FIG. 10 is an explanatory diagram of the timing of each of the signals.

FIG. 11 is a block diagram showing an example of the control circuit 50.

FIG. 12A shows the screen of the various settings menu. FIG. 12B shows the screen urging the user to correct the setting value.

FIG. 13 is a flowchart of the correction process according to the present embodiment.

FIG. 14 is a schematic view showing the entirety of a nozzle check pattern group P70.

FIG. 15A is an explanatory diagram of one nozzle check pattern P71 making up the nozzle check pattern group P70. FIG. 15B is an example of a nozzle check pattern in the case of ejection defects.

FIG. 16 is an explanatory diagram of the configuration of one nozzle check pattern P71.

FIG. 17 is an explanatory diagram of a block pattern BL making up the nozzle check pattern P71.

FIG. 18 is an explanatory diagram of a method for forming nine block patterns BL of one row of the nozzle check pattern P71.

FIG. 19 is an explanatory diagram of a voltage correction pattern.

FIG. 20 is a display screen on the liquid crystal display 72 when the test paper is to be set.

FIG. 21A is an explanatory diagram showing how the test paper is set on the SPC multifunction apparatus 1. FIG. 21B is an explanatory diagram showing the test paper placed on the original bed glass 12 of the scanner section 10.

FIG. 22 is a block diagram showing an overview of an embodiment of a head drive correction device.

FIG. 23 is a flowchart showing the operation of the head drive correction device of FIG. 22 during printing.

For a more complete understanding of the present invention and the advantages thereof, reference is now made to the following description taken in conjunction with the accompanying drawings.

### DESCRIPTION OF PREFERRED EMBODIMENTS

Overview of the Disclosure

At least the following matters will be made clear by the explanation in the present specification and the description of the accompanying drawings.

A printing apparatus comprises:
a head driver for driving a head that ejects ink;
a scanner for reading an image formed on a medium; and
a controller for controlling the head driver to form a correction pattern on the medium, causing the scanner to read the correction pattern that has been formed on the medium, and correcting driving of the head by the head driver based on the results of reading the correction pattern.

With such a printing apparatus, it is possible to reduce the amount of work that is required of the user.

In the foregoing printing apparatus, it is preferable that the controller controls the head driver to form on the medium a check pattern for detecting clogging of the nozzles, causes the scanner to read the check pattern that has been formed on the medium, and detects clogging of the nozzles based on the results of reading the check pattern. It is also preferable that the controller detects clogging of the nozzles based on the check pattern before correcting driving of the head based on the correction pattern. Thus, it is possible to perform accurate correction based on the results of reading the correction pattern. It is also preferable that the scanner does not read the correction pattern if the controller has detected that there is a clogged nozzle. Thus, unnecessary processing can be obviated.

It is preferable that the foregoing printing apparatus further comprises a display section for performing a display indicating that the medium is to be set on the scanner after the correction pattern has been formed on the medium. Thus, tasks by the user can be performed properly.

In the foregoing printing apparatus, it is preferable that the controller controls the head driver to form the correction pattern and a different pattern that is different from the correction pattern on the medium, causes the scanner to read the different pattern that has been formed on the medium, and controls reading of the correction pattern based on the results of reading the different pattern. Thus, the operation of reading the correction pattern is controlled based on the results of reading the different pattern. It is also preferable that the printing apparatus further comprises a display section, that the scanner is for reading images formed on the medium from a predetermined direction, and that after the correction pattern has been formed on the medium, the display section performs a display indicating that the medium is to be set on the scanner such that the different pattern is read by the scanner before the correction pattern. Thus, it is possible to read the different pattern first. It is also preferable that the different pattern is a check pattern for detecting clogging of the nozzles. This is because it is not possible to form the correction pattern properly when nozzles are clogged. It is further preferable that the scanner does not read the correction pattern if the controller has detected that there is a clogged nozzle. Thus, unnecessary processing can be obviated.

In the foregoing printing apparatus, it is preferable that the head driver gives a drive signal to a drive element to drive the head, and that the controller corrects a voltage of the drive signal based on the results of reading the correction pattern. It is also preferable that the printing apparatus further comprises a temperature sensor for detecting a temperature, and that the controller corrects a voltage of the drive signal based on the detection results of the temperature sensor. This is because the viscosity of the ink changes depending on the temperature. It is further preferable that the controller causes the head driver to form the correction pattern in accordance with the drive signal of a voltage that has been corrected based on the detection results of the temperature sensor. Thus, correction values that can be obtained from the correction pattern can be obtained without being affected by the temperature.

It is preferable that the foregoing printing apparatus further comprises a timer for measuring an amount of time that has passed since the correction pattern has been formed. This is because there is a possibility that the darkness of the correction pattern may change in correspondence with the time. It is also preferable that the controller corrects the results of reading according to the measured time that is measured by the timer. This is because the results of the reading may change in correspondence with the time. It is also preferable that the controller puts reading of the correction pattern on standby until the measured time that is measured by the timer reaches a predetermined time. This is to perform reading after the darkness of the correction pattern has become stable.

It is preferable that the foregoing printing apparatus further comprises a display section, and that the controller counts a number of printed sheets and performs a display urging correction when the number of printed sheets that has been counted reaches a predetermined number. It is also preferable that the printing apparatus further comprises a display section, and that the controller counts a number of times of ejections of ink by the head and performs a display urging correction when the number of times of ejections that has been counted reaches a predetermined number. Thus, it is possible to urge the user to perform correction at appropriate timings.

A method for adjusting a printing apparatus, which includes a head driver for driving a head that ejects ink and a scanner for reading an image formed on a medium, comprises forming a correction pattern on the medium with the head driver, reading the correction pattern with the scanner, and correcting driving of the head by the head driver based on the results of reading the correction pattern.

With such an adjustment method, the amount of work that is required of the user can be reduced.

Overview of the Embodiment

This embodiment relates to an inkjet-type printing apparatus in which the printer head of the inkjet-type printing apparatus corrects the drive voltage of the drive elements provided in correspondence with the nozzles for ejecting ink droplets such that an appropriate amount of ink droplets is ejected.

Inkjet-type color printers in which several colors of ink are ejected from a printer head have come to be popular as output apparatuses for computers, and are widely used for printing images that have been processed by a computer or the like in multiple colors and multiple tones.

For example, with inkjet printers that use piezoelectric elements as the drive elements for ink ejection, printing is carried out by selecting a plurality of piezoelectric elements provided in correspondence with the plurality of nozzles of the printer head using a nozzle selection switch circuit and driving them, thereby ejecting ink droplets from the nozzles based on the voltage of the piezoelectric elements, and causing ink droplets to land on the print paper, thereby forming dots on the print paper.

Here, the piezoelectric elements are provided in correspondence with the nozzles for ejecting ink droplets and are driven by drive signals that are supplied from a head drive section that is installed in the main printer unit, thereby effecting the ejection of ink droplets.

Incidentally, it is known that when printing is executed using an inkjet printer, the temperature within the printer device increases due to the heat that is generated by the elements on the circuit board or motors due to printing. Thus, among conventional inkjet printers, there are those in which the temperature of the head environment is detected in order to correct the drive waveform, such as that disclosed in Japanese Patent Application Examined Publication (Kohyo) No. 6-41205, for example.

However, in such inkjet printers, the correction value of the drive voltage of the drive waveform serving as the basis for correction does not change, and temperature compensation is performed by correcting the drive waveform through correction based on the temperature.

In contrast, the properties of piezoelectric elements change over time as they are used, and in general, this tends to lead to a larger ink ejection amount at the same drive voltage.

For this reason, when printing using conventional ink-jet printers, the change in properties of the piezoelectric elements as they gradually change over change results in an increase in the amount per ink droplet that is ejected onto the print medium, and can lead to a drop in printed image quality.

Also, in recent inkjet printers, the total ink usage amount, or in other words, the amount of ink remaining, is managed based on the number of ink ejections by the piezoelectric elements, and thus when the amount of ink ejected by the piezoelectric elements changes, it is no longer possible to manage the amount of ink remaining.

By contrast, there are printing apparatuses in which, when used for the first time or when an ink cartridge is changed, a print pattern for correction is first printed and the user visually checks the print pattern for correction that has been printed and determines an appropriate correction value, and then the user manually inputs this value in order to correct the ink ejection amount. However, such printing apparatuses require tedious tasks of the user and rely on the subjectivity of the user, and thus it is difficult to perform correction properly.

The problem of the ink ejection amount changing due to changes in the piezoelectric elements over time is not limited to inkjet printers, and is also present in other types of ink-jet printing apparatuses, such as inkjet-type digital copying machines, facsimile machines, and digital multifunction machines, in which ink droplets are ejected by piezoelectric elements.

Also, in such inkjet printing apparatuses, there are instances in which the printing position in the directions of movement of the printer head when bidirectional printing is performed (hereinafter, referred to as the “bidirectional printing position”) shifts as a consequence of the printing apparatus being used, and when printing large characters or images, for example, the entire character or image, for example, may be slightly shifted, causing deterioration of the image quality.

On the other hand, inkjet printing apparatuses to which a so-called scanner function has been added are known. This scanner function is achieved by arranging image reading means near the position where the printer head is located, reading an image on the print medium with the image reading means, and outputting it to the outside as electric signals.

Accordingly, one of the issues of the present embodiment is to provide an inkjet printing apparatus, as well as a head drive correction device and method thereof, that has a simple configuration with which an image reading means is used to correct various setting values, such as the ink ejection amount or the bidirectional printing position, in correspondence with the change in properties over time of the drive elements.

To solve the foregoing issue, in the present invention, a correction pattern is first printed with a correction section, then the correction pattern that has been printed is read using the image reading means, and based on the printing results of that print pattern, a correction value corresponding to each of the various setting values is calculated and output to the head drive section.

That is, the head drive correction device according to the present embodiment is a head drive correction device in an inkjet-type printing apparatus, provided with image reading means and in which drive elements, which are for applying pressure to ink and are provided corresponding to the plurality of nozzles, are selectively driven by drive signals from the head drive section at a predetermined print timing such that ink droplets are ejected from corresponding nozzles to carry out printing, and is characterized in that it is provided with a correction section for reading, with the image reading means, a print medium on which a print pattern for correction has been printed by driving the drive elements with drive signals from the head drive section, and based on the print results of the print pattern, calculating the correction values for the various setting values and outputting them to the head drive section.

With this configuration, the correction section causes the head drive section to drive the drive elements to print a print pattern for correction on the print medium, and then employs the image reading means to read the print medium on which the print pattern for correction has been printed. Then, the correction section calculates the correction value for the various setting values from the print results of the print pattern based on the image data read by the image reading means, and outputs the correction value to the head drive section. Thus, the head drive section drives the drive elements to execute printing based on this correction value, and thus printing can be performed correctly. Consequently, deterioration of the printed image quality are inhibited, resulting in printing that is easy to look that.

Thus, with the head drive correction device in the ink-jet printing apparatus according to the present embodiment, an image reading means is employed to read a print pattern for correction that has been printed on a print medium and the various setting values are corrected based on the results of that printing, and thus correction can be carried out easily.

Also, in the present embodiment, the drive elements are characterized in that they are constituted by piezoelectric elements. With this configuration, even if the properties of the piezoelectric elements change over time, correction with respect to this change in properties is possible.

Also, the present embodiment is characterized in that the image reading means and the printer are a single unit. With this configuration, it is possible to use an image reading means that is in a single unit with the printer to correct the various setting values, and thus, it is convenient in terms that it is not necessary to provide a separate scanner, for example.

The present embodiment is further characterized in that the correction section calculates the correction value for the various setting values with reference to detection signals from a temperature sensor provided near the printer head. With this configuration, when the correction section calculates the correction value for the various setting values, it references the temperature near the printer head that is detected by the temperature sensor in order to calculate the correction value for the drive voltage, and thus it is possible to simultaneously perform temperature compensation.

The present embodiment is further characterized in that the correction section is provided with storing means for storing the correction value for the various setting values. With this configuration, the storing means stores the correction value until the next correction value, and thus that correction value can be read out at any time. For example, even if the power of the inkjet printing apparatus is turned off, the next time that it is turned on, the head drive device can create drive signals based on the various setting values that have been properly corrected using correction values read from the storing means.

The present embodiment is further characterized in that the correction section stores an initial value for the various setting values on the storing means, and when there has been a request, it changes the correction value corresponding to the various setting values back to the initial value. With this configuration, if the correction section has calculated an incorrect correction value due to a malfunction etc., then, for example, the initial value of the various setting values is read from the storing means by the correction section in accordance with a command that has been input manually by the user or an automatic command from the main printing apparatus unit, and outputs this to the head drive section, whereby the various setting values within the head drive section are changed back to the initial value.

The present embodiment is further characterized in that one of the various setting values is the drive voltage of the drive signals from the head drive section. With this configuration, the correction section calculates the correction value of the drive voltage of the drive signals from the head drive section based on the print darkness, which is the printing result of the print pattern, that is obtained through reading of the print pattern for correction, and outputs this correction value to the head drive section. Thus, the head drive section, by creating drive signals based on this correction value, compensates for changes in the ink ejection amount due to changes in the drive elements over time, thereby suitably correcting the ink ejection amount.

Consequently, a drop in the printed image quality due to changes in the ink ejection amount is prevented, and by suitably correcting the ink ejection amount, it is possible to accurately manage the total amount of ink, as well as the remaining ink amount, through the use of the number of times of ink ejections.

The present embodiment is further characterized in that one of the various setting values is the bidirectional printing position of printer head. With this configuration, the correction section calculates the correction value of the bidirectional printing position of the printer head based on the printing position, which is the printing result of the print pattern, that is obtained through reading of the print pattern for correction, and outputs this correction value to the head drive section. Thus, the head drive section creates drive signals based on this correction value, thereby compensating for shifting in the bidirectional printing position that follow from use and making it possible for printing to be carried out at correct printing positions.

Consequently, when large characters or images, for example, are printed, the entire character or image can be printed at a correct position, thereby preventing a drop in image quality.

The present embodiment is further characterized in that the correction section counts the number of sheets printed by the printer head, and when the number of printed sheets reaches a predetermined number, makes a display urging correction on a display section of the main printer unit.

The present embodiment is further characterized in that the correction section counts the number of times of ejections by the printer head, and when the counted number reaches a predetermined number, makes a display urging correction on a display section of the main printer unit or a monitor of a personal computer, for example.

With this configuration, when the number of printed sheets or the number of times of ejections by the inkjet printing apparatus reaches a predetermined number, the user can visually confirm a display urging correction on the display section of the main printer unit, for example, and can thereby execute correction of the various setting values through the correction section. Thus, correction of the various setting values can be performed reliably, and even if miniscule changes in the various setting values, such as the ink ejection amount or the bidirectional printing position, that cannot be visually confirmed by the user occur, correction of such changes can be reliably performed.

Embodiments of the present invention are described below with reference to the drawings. It should be noted that the embodiments described below are preferable specific examples of the present invention, and thus various limitations that are preferable from a technical standpoint are added, but the scope of the present invention is not limited to these embodiments unless particular mention limiting the present invention is made in the following description.

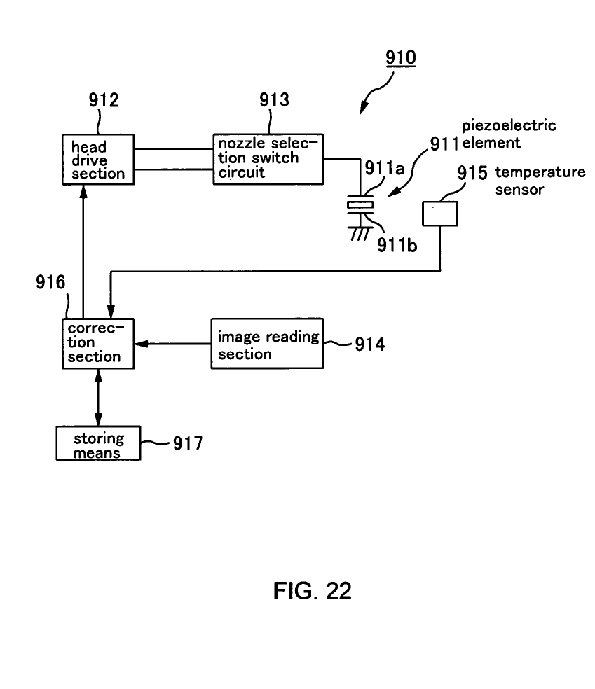

FIG. 22 shows an embodiment of the head drive correction device of an inkjet printer adopting the present invention. In FIG. 22, a head drive correction device 910 is made of piezoelectric elements 911 serving as drive elements each of which being provided corresponding to each of a plurality of nozzles of the printer head of the inkjet printer, a head drive section 912 for supplying a drive signal to one electrode 911a in each of the piezoelectric elements 911, a nozzle selection switch circuit 913 provided between the head drive section 912 and the piezoelectric elements 911, an image reading section 914 attached to the printer head, a temperature sensor 915 attached to the printer head, and a correction section 916.

Here, only a single piezoelectric element 911 is shown in FIG. 22, but in practice, a plurality of nozzles are provided in the printer head of the inkjet printer, and a single piezoelectric element is provided for each nozzle.

In practice, drive signals from the head drive section 912 are consecutively supplied to the piezoelectric elements 911 via a shift register or the like.

The piezoelectric elements 911 are, for example, piezo elements whose shape is changed due to a voltage that is applied between the electrodes 911a and 911b.

The piezoelectric elements 911 are normally charged to near an intermediate potential, and apply pressure to the ink within the nozzles based on the drive signals from the head drive section 912 such that ink droplets are ejected from the nozzles.

The head drive section 912 is for generating drive signals for the printer head of the inkjet printer, and is arranged in the main printer unit. Also, the head drive section 912 is configured such that it creates drive signals based on a setting value of a drive voltage that has been set in advance.

The nozzle selection switch circuit 913 receives control signals from the controller of the main printer unit and thus is turned on at the drive timing of the corresponding piezoelectric elements 911 and outputs drive signals to the piezoelectric elements 911. In practice, the switch circuit 913 is made of a so-called transmission gate for turning each of the piezoelectric elements 911 on and off.

The image reading section 914 is for achieving the scanner function, and for example, is a CCD or the like in a single unit with the printer.

Also, the image reading section 914 scans a print medium so as to read a print pattern on the print medium, and outputs this to the correction section 916, which is described later, as image data.

The temperature sensor 915 is arranged near the printer head, and detects the temperature around the printer head, that is, it detects a rise in the temperature inside the device due to heat generated by elements on the circuit board or motors during printing, and outputs a detection signal to the correction section 916.

The correction section 916 causes the printer head to print a print pattern for correction, causes the image reading section 914 to read the print pattern for correction, and then calculates a correction value for the drive voltage according to the image data of the print pattern that has been read.

That is, the correction section 916, for example, outputs a print command for a print pattern for correction to the head drive section 912 such that the head drive section 912 drives the piezoelectric elements 911 and thereby prints the print pattern for correction on the print medium with the printer head.

Here, the print pattern for correction is provided with a stepwise gradation for each color, for example.

Next, the correction section 916, for example, outputs a read command for the print pattern for correction to the image reading section 914, causing the image reading section 914 to read the print medium on which the print pattern for correction has been printed.

The correction section 916 then selects a pattern with the most suitable print darkness from among the stepwise gradations based on the image data of the print pattern for correction from the image reading section 914, and calculates the correction value of the drive voltage based on the print position of that pattern.

Here, in order to select the pattern with the most suitable print darkness, the correction section 916, for example, retains reference data serving as a threshold value that has been set in advance, and compares the image data with this reference data, thereby being able to select the pattern with the most suitable print darkness.

The correction section 916 is further provided with storing means 917 for storing the correction value of the drive voltage that has been calculated and the initial value of the drive voltage. The storing means 917 is, for example, a nonvolatile memory such as an EEPROM, and is capable of retaining stored data even after the power of the main printer unit has been turned off.

In this way, when creating a drive signal, the head drive section 912 reads the correction value, or the initial value if no correction value has been stored, of the drive voltage from the storing means 917 of the correction section 916 and creates the drive signals based on the correction value or the initial value of the drive voltage that has been read.

The head drive correction device 910 according to this embodiment of the present invention is configured as described above and operates as described below. That is, at the time of printing, when a drive signal is output from the head drive section 912, the nozzle selection switch circuit 913 drives the piezoelectric elements 911 based on this drive signal. This driving of the piezoelectric elements 911 results in ink being ejected onto a print medium, thereby carrying out printing.

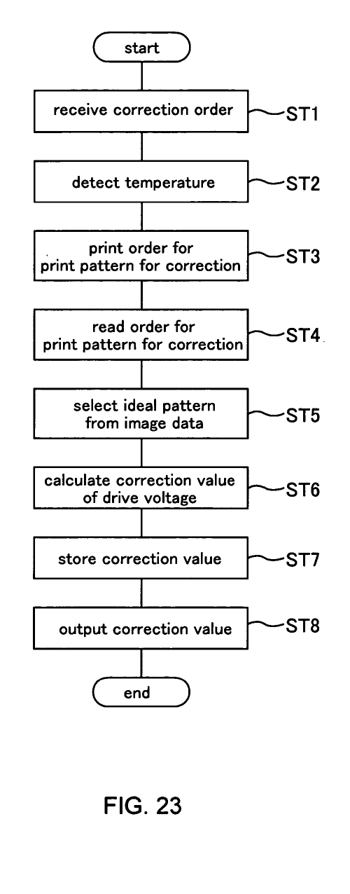

Next, a case in which the drive voltage is corrected is described with reference to the flowchart of FIG. 23. In FIG. 23, in step ST1, the correction section 916 receives, for example, a correction command that is manually input by the user through a control panel of the main printer unit or a correction command that is automatically generated from the controller of the main printer unit, and in step ST2, the correction section 916 detects the temperature T around the printer head based on the detection signal from the temperature sensor 915.

Next, instep ST3, the correction section 916 outputs a print command for a print pattern for correction to the head drive section 912 such that the piezoelectric elements 911 are driven by the head drive section 912, thereby printing the print pattern for correction on the print medium using the printer head.

Then, in step ST4, the correction section 916 outputs a read command for the print pattern for correction to the image reading section 914 to cause the image reading section 914 to read the print medium on which the print pattern for correction has been printed by the printer head.

Next, in step ST5, the correction section 916 compares the image data of the print pattern for correction from the image reading section 914 with the reference data that has been set in advance, and selects the pattern that yields the most suitable print darkness from among the stepwise gradations.

In step ST6, the correction section 916 then references the temperature T that is detected by the temperature sensor 915 while calculating the correction value of the drive voltage based on the print position of the pattern that has been selected.

Lastly, in step ST7, the correction section 916 stores, on the storing means 917, the correction value of the drive voltage that has been calculated and in step ST8 outputs this correction value of the drive voltage to the head drive section 912 to set a new drive voltage. In this fashion, correction of the drive voltage is completed.

It should be noted that in the foregoing operation, it is possible for setting of the print medium when printing the print pattern for correction, or setting of the print medium when reading the print pattern for correction, to be performed by the user by having the correction section 916 make a display that urges setting of the print medium on the display section of the main printer unit or, if the correction section 916 is connected to an external device such as a personal computer via a two-way interface, the display section of that external device.

Here, if the printer is provided with an automatic paper feed function, then when printing the print pattern for correction, it is possible for printing to be carried out by automatically feeding the paper without making the display.

By having the user set the print medium, it becomes possible to make corrections easily, inexpensively, and with a simple configuration based on a print pattern for correction using a conventional printer with a scanner function.

In the foregoing embodiment, the correction section 916 references the temperature T detected by the temperature sensor 915 while calculating the correction value of the drive voltage based on the image data obtained by reading the print pattern for correction, but this is not a limitation, and it is also possible for the correction value of the drive voltage to be calculated without referencing the detected temperature T. In this case, temperature compensation can be performed as in the past such that when the head drive section 912 creates drive signals the shape of the drive waveform is changed based on the detected temperature T.

Also, in the foregoing embodiment, the correction section 916 calculates the correction value of the drive voltage based on the image data that are obtained by reading the print pattern for correction, but this is not a limitation, and it should be apparent that other various setting values, such as the bidirectional print position, can be corrected.

Moreover, the foregoing embodiment describes a case in which the present invention is adopted for an inkjet printer, but this is not a limitation, and it should be clear that the present invention can also be adopted for other types of inkjet printing apparatuses, such as inkjet-type digital copying machines, facsimile machines, and digital multifunction machines.

As discussed above, according to the present embodiment, the correction section makes the head drive section drive the piezoelectric elements to print a print pattern for correction on the print medium, and then employs the scanner function to read the print medium on which this print pattern for correction has been printed using the image reading means.

Then, the correction section calculates the correction value for the various setting values from the print results of the print pattern based on the image data read by the image reading means, and outputs this correction value to the head drive section.

In this way, by the head drive section driving the piezoelectric elements based on the correction value to carry out printing, printing can be performed correctly. Consequently, deterioration in the image quality due to printing are inhibited, allowing printing that is easy look at to be carried out.

Consequently, with the head drive correction device of the inkjet printing apparatus according to the present embodiment, the scanner function is employed to read a print pattern for correction that has been printed on a print medium, and based on the results of this printing, the various setting values are corrected, and thus correction can be carried out easily.

In this manner, with the head drive correction device of the inkjet printer according to the present invention, it is possible to employ the scanner function to correct, with a simple configuration, the various setting values, such as the ink ejection amount or the bidirectional printing position, in correspondence with the changes in the properties of the piezoelectric elements due to changes over time.

Configuration of the Present Embodiment

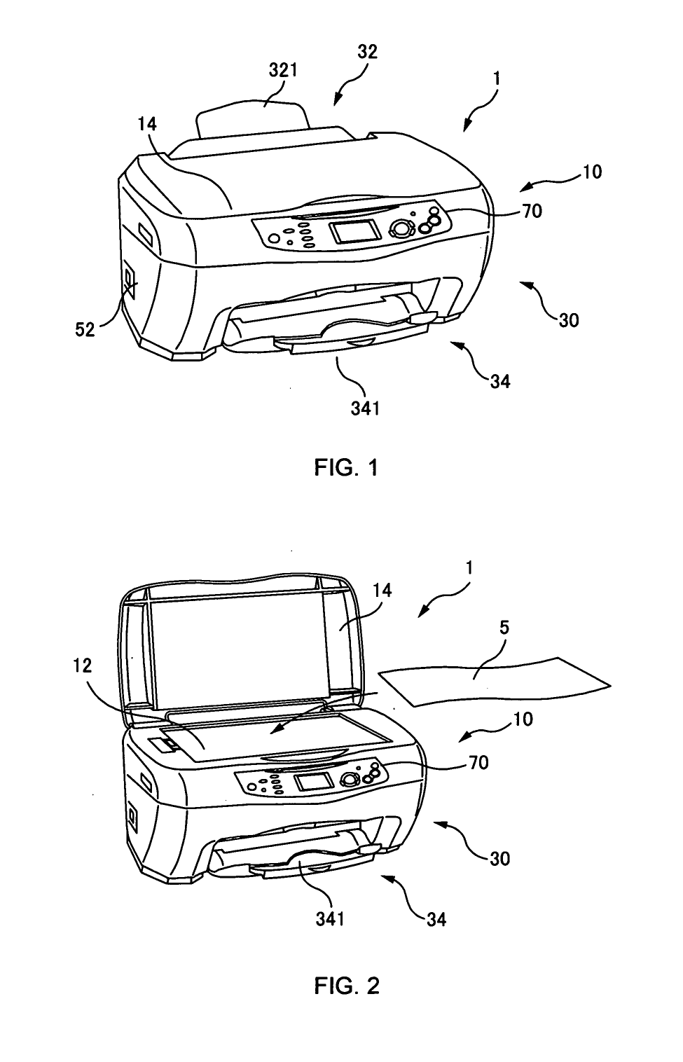

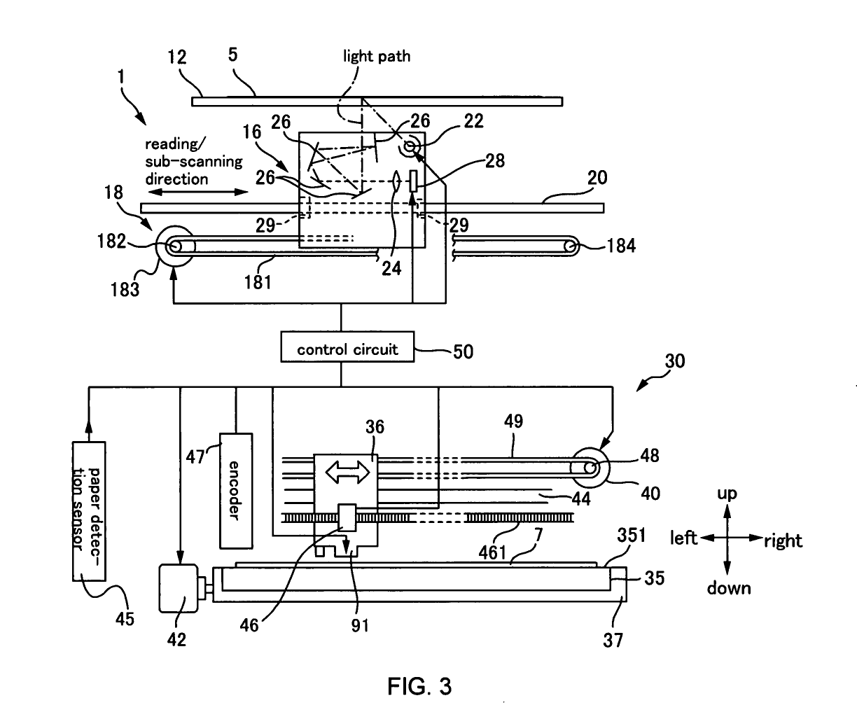

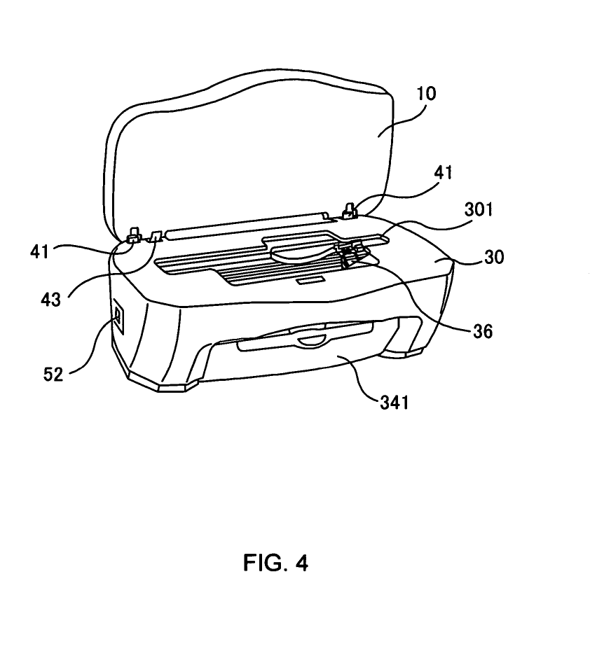

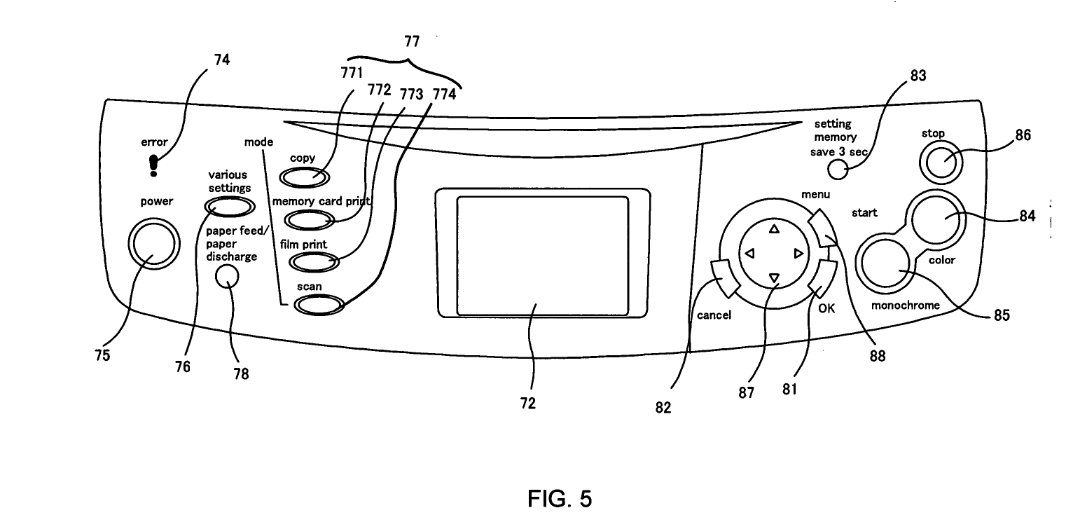

A schematic configuration of the recording apparatus according to the present embodiment is described with reference to FIGS. 1 to 5. FIG. 1 is a perspective view showing the schematic configuration of the recording apparatus according to the present embodiment. FIG. 2 is a perspective view showing the appearance when the cover of a scanner section 10 is open. FIG. 3 is an explanatory diagram showing the internal configuration of the recording apparatus. FIG. 4 is a perspective diagram showing the exposed interior of the printer section. FIG. 5 is a diagram showing an example of the control panel section. The recording apparatus of the present embodiment is a scanner/printer/copier multifunction device (hereinafter, referred to as “SPC multifunction apparatus”) having a scanner function for inputting an original document image, a printer function for printing an image on a medium such as paper based on image data, and a local copy function for printing an image that has been input by the scanner function onto paper or the like.

An SPC multifunction apparatus 1 has a scanner section 10 for reading the image of an original document 5 and inputting it as image data, a printer section 30 for printing an image on a medium such as paper based on image data, a control circuit 50 for governing the overall control of the SPC multifunction apparatus 1, and a control panel section 70 serving as input means. Due to control by the control circuit 50, the scanner function, the printer function, and the local copy function for printing the data input from the scanner section 10 using the printer section 30, are achieved.

The scanner section 10 is arranged above the printer section 30, and in an upper section of the scanner section 10 are provided an original bed glass 12 on which the original document 5 to be read is placed, and an original bed cover 14 for covering the original bed glass 12 when reading a sheet-shaped original document 5 or when not in use. The original bed cover 14 is formed such that it can be opened and closed, and when closed it also has the function of pressing an original document that has been placed on the original bed glass 12 toward the original bed glass 12. Also, a paper supply section 32 for supplying paper 7 to the printer section 30 is provided on the rear side of the SPC multifunction apparatus 1, and a paper discharge section 34 through which a paper 7 that has been printed is discharged and the control panel section 70 serving as input means are provided on the lower side and the upper side, respectively, of the front side of the SPC multifunction apparatus 1. The control circuit 50 is provided in the printer section 30.

The paper discharge section 34 is provided with a paper discharge tray 341 that is capable of covering the paper discharge opening when the printer is not in use, and the paper supply section 32 is provided with a paper supply tray 321 for holding cut paper (not shown). Examples of media that are used for printing include not only single sheets of print paper such as cut paper but also continuous print paper such as roll paper. The SPC multifunction apparatus 1 can also be provided with a paper feed mechanism that allows roll paper to be printed.

As shown in FIG. 4, the printer section 30 and the scanner section 10 are linked at the rear surface side by a hinge mechanism 41. The scanner section 10 provided as a unit is lifted up on the forward side about the rotation section of the hinge mechanism 41. With the scanner section 10 in a raised state, the interior of the printer section 30 is exposed through an opening 301 provided in the upper section of the cover that covers the printer section 30. The configuration is such that by exposing the interior of the printer 30 in this manner, it is possible to easily exchange the ink cartridges etc. and fix paper jams etc.

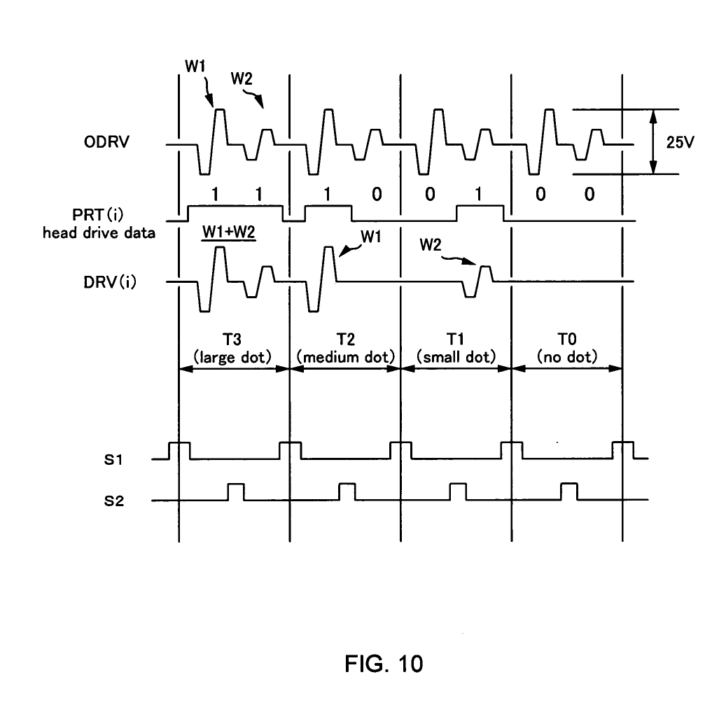

Also, a power source for the SPC multifunction apparatus 1 is provided on the printer section 30 side, and a power supply cable 43 for supplying power to the scanner section 10 is provided near the hinge mechanism 41. Further, the SPC multifunction apparatus 1 is provided with a USB interface 52 for outputting image data (during the scanner function) to a host computer 3 (see FIG. 10) and receiving image data transmitted from the host computer 3 (during the printer function).

Configuration of the Control Panel Section 70

As shown in FIG. 5, the control panel section 70 is provided with a liquid crystal display 72 substantially in its center. The liquid crystal display 72 is capable of displaying characters and images alike. The information that is displayed by the liquid crystal display 72 changes according to the setting item, the setting state, or the operation state, for example.

To the left of the liquid crystal display 72 are provided a notification lamp 74, a power button 75, a various settings button 76, mode buttons 77, and a paper feed/discharge button 78. The notification lamp 74 is a red LED, and notifies the user by lighting up when an error has occurred. The power button 75 is a button for turning the power of the SPC multifunction apparatus 1 on and off. When the various settings button 76 is pressed, a screen for altering the various settings of the SPC multifunction apparatus 1 is displayed on the liquid crystal display 72. A copy mode button 771, a memory card print mode button 772, a film print mode button 773, and a scan mode button 774 are provided as the mode buttons 77. When these buttons are pressed, a screen for changing the settings of these modes is displayed on the liquid crystal display 72. For example, when the copy mode button 771 is pressed, a screen for inputting setting conditions, such as the number of copies, the zoom factor, the paper type, the paper size, the copy quality, and the copy mode, is displayed on the liquid crystal display 72. The paper feed/discharge button 78 is pressed to feed paper to the SPC multifunction apparatus or to discharge paper within the SPC multifunction apparatus.

To the right of the liquid crystal display 72 are provided an OK button 81, a cancel button 82, a save button 83, a color copy button 84, a monochrome copy button 85, a stop button 86, a multidirectional button 87, and a menu button 88. When the OK button 81 is pressed, the setting conditions are set to the content displayed on the liquid crystal display 72. When the cancel button 82 is pressed, the setting conditions are cleared and the various setting fields are changed to default values. When the save button 83 is pressed for three or more seconds, the setting values are stored. When the save button 83 is pressed for less than three seconds, then the saved setting values are read out and those setting conditions are displayed on the liquid crystal display 72. The color copy button 84 is a button for starting color copying, and the monochrome copy button 85 is a button for starting monochrome copying. Consequently, these copy buttons 84 and 85 function both as means for performing a copy operation start command and as selection means for selecting whether an image to be printed is color or monochrome. The stop button 86 is a button for stopping the copy operation after it has started. The multidirectional button 87 can be selectively pushed at four areas at the top, bottom, left, and right, and is a single button that serves four functions (up button, down button, left button, and right button functions). When the menu button 88 is pressed, the setting fields shown on the liquid crystal display 72 are switched.

Configuration of the Scanner Section 10

The scanner section 10 is made of the original bed glass 12 on which the original document 5 to be read is placed, the original bed cover 14 for pressing the reading surface of the original document 5 that has been placed on the original bed glass 12 toward the original bed glass 12, a read carriage 16 for scanning along the original document 5 while maintaining a constant distance between it and the original document 5 in opposition thereto via the original bed glass 12, drive means 18 for scanning with the read carriage 16, and a regulating guide 20 for scanning with the read carriage 16 in a stable state. The scanner section 10 is an image reading section (scanner) for reading images of the original document 5.

The read carriage 16 is made of an exposure lamp 22, which is a light source, for irradiating light onto the original document 5 via the original bed glass 12, a lens 24 for focusing the light that is reflected by the original document 5, four mirrors 26 for guiding the light reflected by the original document 5 to the lens 24, a CCD sensor 28 for receiving the reflection light that has passed through the lens, and a guide reception section 29 that engages with the regulating guide 20.

The CCD sensor 28 is made of three linear sensors in which photodiodes for converting an optical signal into an electric signal are arranged in rows, and these three linear sensors are arranged parallel to one another. The CCD sensor 28 is provided with three filters, namely R (red), G (green), and B (blue) filters, that are not shown, and each linear sensor is provided with a different color filter. The linear sensors each detect the light of components that correspond to the color of the filter. For example, the linear sensor provided with the R filter detects the intensity of the red component of the light. The three linear sensors are arranged in a direction (hereinafter, referred to as the “main-scanning direction”) that is substantially perpendicular to the direction in which the read scanner 16 moves (hereinafter, referred to as the “sub-scanning direction”).

The length of the CCD sensor 28 is sufficiently shorter that the width (length in the main-scanning direction) of an original document 5 that can be read, and thus the image that is obtained from the reflection light of the original document 5 is reduced in size by the lens 24 and formed on the CCD sensor 28. In other words, it is necessary to arrange the lens 24, which is interposed between the original document 5 and the CCD sensor 28, near the CCD sensor 28 side and to set a long distance between the original document 5 and the lens 24, such that a long light path length is obtained. For this reason, a long light path length is secured by reflecting with four mirrors 26 such that distance can be secured between the original document 5 and the lens 24 within the limited space of the read carriage 16 that is scanned.

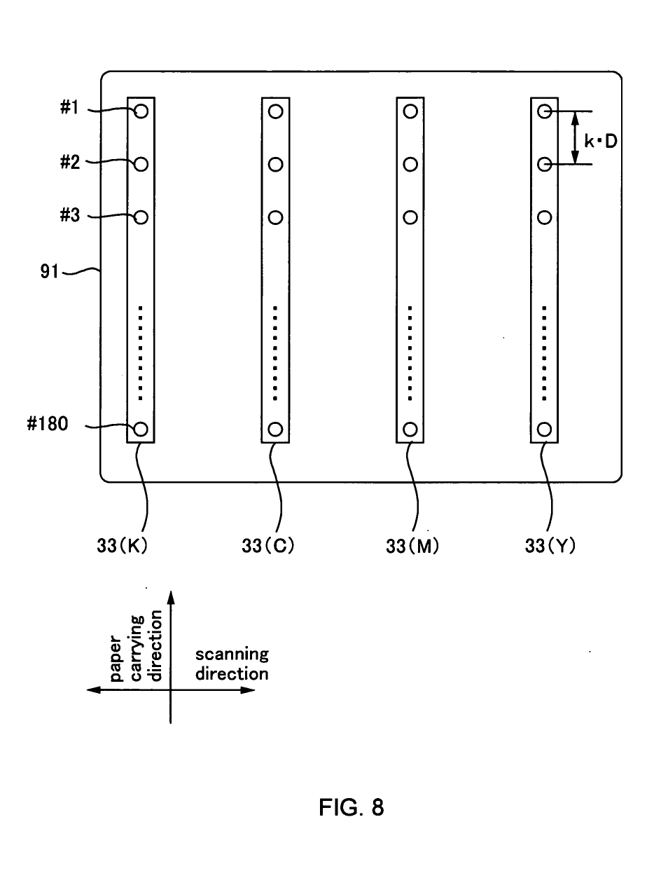

Further, the light that is reflected by the original document 5 is reflected by the four mirrors 26 and passes through the lens 24 before arriving at the CCD sensor 28, but since the three linear sensors are arranged parallel to one another, the positions on the original document from which the light that simultaneously forms an image on the linear sensors is reflected are displaced in the sub-scanning direction by the amount of the spacing between the linear sensors. Thus, a scanner control unit 58 (FIG. 8) of the control circuit 50 performs interline correction in order to correct this displacement.

The regulating guide 20 is provided along the sub-scanning direction and is made of a stainless steel cylindrical material. The regulating guide 20 is provided in the read carriage 16 and passes through two guide reception sections 29 made of thrust bearings. By widening the distance in the sub-scanning direction between the two guide reception sections 29 provided in the read carriage 16, it becomes possible to scan the read carriage 16 in a stabilized manner.

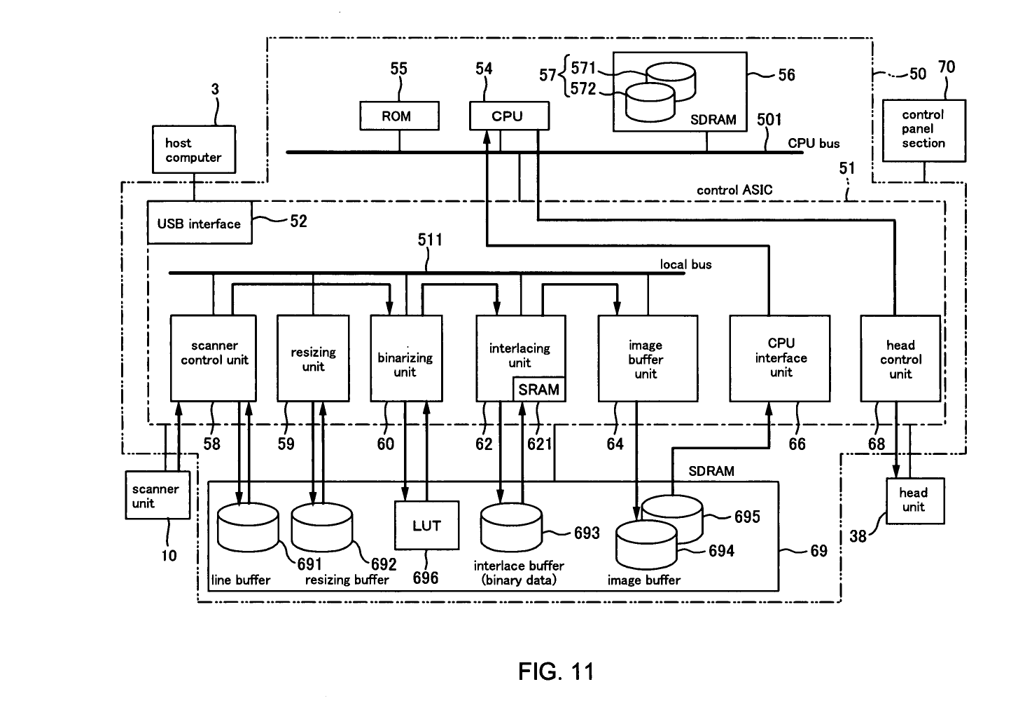

The drive means 18 is made of an annular timing belt 181 fastened to the read carriage 16, a pulley 182 that meshes with the timing belt 181, a pulse motor 183 that is arranged on one end side in the sub-scanning direction, and an idler pulley 184 arranged on the other end side for applying tension to the timing belt 181. The pulse motor 183 is driven by the scan controller 58 (FIG. 11) of the control circuit 50, and due to the scanning velocity of the read carriage 16, which changes in response to the velocity of the pulse motor 183, it is possible to magnify or shrink the read image in the sub-scanning direction.

Further, in the scanner section 10, the light of the exposure lamp 22 is irradiated onto the original document 5 and the light that is reflected forms an image on the CCD sensor 28 while the read carriage 16 is moved along the original document 5. At this time, by performing reading at a predetermined cycle as a voltage value indicating the amount of light received by the CCD sensor 28, an image corresponding to the distance that the read carriage 16 has moved in a single cycle is fetched as one line of data of the image to be output. At this time, the R component, the G component, and the B component are obtained as one line of data.

Configuration of the Printer Section 30

The printer section 30 has a configuration that permits the output of color images, and adopts an inkjet method in which inks of, for example, the four colors of cyan (C), magenta (M), yellow (Y), and black (K) are ejected onto a medium such as print paper to form dots and thereby form images. It should be noted that in addition to the above four colors, it is also possible to use as the color inks light cyan (LC), light magenta (LM), and dark yellow (DY).

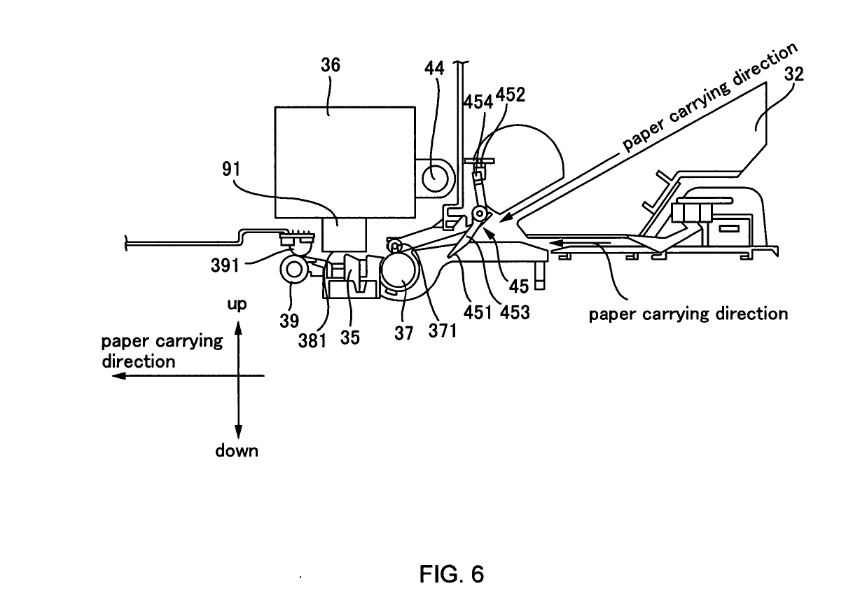

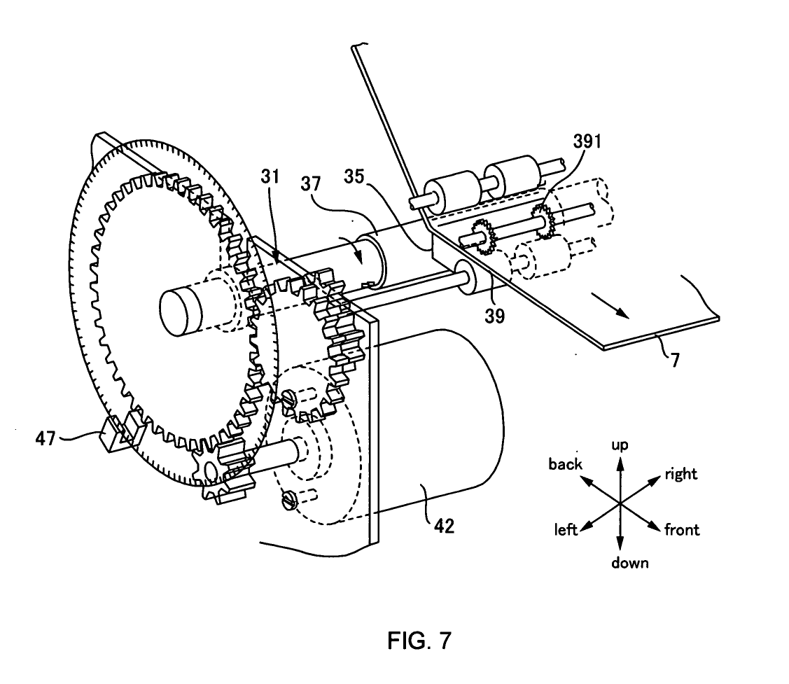

The printer section 30 is described next with reference to FIGS. 3, 6, and 7. FIG. 6 is an explanatory diagram showing the arrangement around the print head, and FIG. 7 is an explanatory diagram for describing the drive section of the print paper carrying mechanism.

The printer section 30, as shown in the figures, has a head unit 38 that drives a head mounted on a write carriage 36 to eject ink and form dots, a carriage drive mechanism for moving the write carriage 36 back and forth in the direction perpendicular to the direction in which the paper 7 is carried by a carriage motor 40, and a paper carrying mechanism for carrying the paper 7, which is supplied from the paper feed tray 321 (see FIG. 1) by a paper feed motor 24 (hereinafter, also referred to as “carry motor” or “PF motor”).

The head unit 38 is provided with a head 91 having a plurality of nozzles serving as ink ejection sections, and ejects ink from predetermined nozzles based on print command signals. A plurality of nozzles form rows in the lower surface 381 of the head 91 in the carrying direction of the paper 7, and the plurality of rows of nozzles are provided in the direction perpendicular to the carrying direction of the paper 7. The head unit 38 and the nozzle arrangement are described in greater detail later.

The carriage drive mechanism is made of the carriage motor 40 (hereinafter, also called the “CR motor”), a slide shaft 44, a linear encoder 46, a linear encoder code plate 461, the pulley 48, and the timing belt 49. The CR motor 40 is for driving the write carriage 36. The slide shaft 44 is provided in the direction perpendicular to the carrying direction of the paper 7 and slidably holds the write carriage 36. The linear encoder 46 is fastened to the write carriage 36. The linear encoder code plate 461 is provided with slits that are formed at a predetermined spacing. The pulley 48 is attached to the rotational shaft of the carriage motor 40. The timing belt 49 is driven by the pulley 48.

To the write carriage 36 are fastened the head 91 and a carriage mount section that is provided in a single unit with the head 91, and to the cartridge mount section are mounted ink cartridges containing ink such as black (K), cyan (C), magenta (M), and yellow (Y) ink.

The carrying mechanism has a platen 35, a carry roller 37, a paper discharge roller 39, a PF motor 42, a rotary encoder 47, and a paper detection sensor 45. The platen 35 is arranged in opposition to the head 91 and is a guide member for guiding the paper 7 so that the paper 7 and the head 91 are at a suitable distance from one another. The carry roller 37 is provided on the upstream side in the carrying direction of the paper 7 with respect to the platen 35 and carries the supplied paper 7 in such a manner that it is in contact with the platen 35 at a predetermined angle. The paper discharge roller 39 is provided on the downstream side in the carrying direction of the paper 7 with respect to the platen 35 and is for carrying the paper 7 that has been released from the carry roller 37 and discharging it. The PF motor 42 is for driving the carry roller 37 and the paper discharge roller 39. The rotary encoder 47 is for detecting the amount that the paper 7 has been carried. The paper detection sensor 45 is for detecting whether or not the paper 7 is present and detecting the front end and the rear end of the paper 7.

The carry roller 37 is provided below the carry route of the paper 7, and above it is provided a driven roller 371 for holding the paper 7 in opposition to the carry roller 37. The paper discharge roller 39 is also provided below the carry route of the paper 7, and above it is provided a driven roller 391 for holding the paper 7 in opposition to the paper discharge roller 39. However, the driven roller 391 in opposition to the paper discharge roller 39 is a roller that is a thin plate provided with fine teeth in its outer periphery, such that ink is kept from rubbing up against it even if it comes into contact with the surface of the paper 7 after printing.

The position where the carry roller 37 and the paper 7 contact one another is arranged higher than the position where the platen 35 and the paper 7 contact one another. In other words, the paper 7 carried from the carry roller 37 can be brought into contact with the platen 35 at a predetermined angle and further carried. In this way, the paper 7 is carried such that it is pushed against the guide surface of the platen 35, and therefore satisfactory images can be obtained because the paper 7 is kept at a suitable position from the nozzles by the platen 35.

Also, the carry roller 37 and the paper discharge roller 39 are linked by a gear train, rotated by the rotation of the PF motor 1 that is transferred thereto, and both rollers 37 and 39 carry the paper 7 at the same velocity.

The platen 35 has a guide surface that is in opposition to the lower surface 381 of the head 91 and that comes into contact with and guides the paper 7. The guide surface is formed narrower than the region in which the nozzles of the lower surface 381 of the head 91 are provided, and several of the nozzles positioned on the most upstream side and the most downstream side in the carrying direction of the paper 7 are not in opposition to the platen 35. Thus, when printing the front and the rear end of the paper 7, ink ejected outside of the paper 7 is kept from adhering to the platen 35, thereby preventing the rear surface of paper 7 that is carried later from becoming dirty. In other words, the platen 35 is not provided at positions in opposition to the nozzles on the upstream side end and the downstream side end, leaving an open space. In this space is provided an ink tray that is positioned lower than the guide surface 351 of the platen 35 and that collects unnecessary ink to keep the inside of the printer from becoming dirty.

The paper detection sensor 45 is provided upstream of the carry roller 37 in the carrying direction, and has a lever 451 having a rotation center at a position higher than the carry route of the paper 7 and a transmission-type sensor 452 that is provided above the lever 451 and that has a light-emitting section and a light-receiving section. The lever 451 is constituted by an action section 453 that is arranged so that it hangs into the carry route under its own weight and that is rotated by the paper 7 that is supplied from the paper feed tray 321, and a light-blocking section 454 that is positioned opposite the action section 453, sandwiching the rotation center between them, and that is provided in such a manner that it passes between the light-emitting section and the light-receiving section. The paper detection sensor 45 detects that the paper 7 has arrived at a predetermined position because the light-blocking section 454 blocks the light that is emitted by the light-emitting section when the lever 451 is pressed by the paper 7 that has been supplied and the paper 7 arrives at the predetermined position. Then, when the paper 7 is carried by the carry roller 37 and the rear end of the paper 7 passes the paper detection sensor 45, the paper detection sensor 45 detects that the rear end of the paper 7 has arrived at a predetermined position, as the lever 451 hangs down under its own weight and removes the light-blocking section 454 from between the light-emitting section and the light-receiving section such that the light from the light-emitting section is received by the light-receiving section. Consequently, at a minimum, it is detected that the paper 7 is on the carry route during the period that the light-blocking section 454 blocks the light from the light-emitting section.

Regarding the Configuration of the Nozzles

FIG. 8 is an explanatory diagram showing the arrangement of the nozzles in the lower surface 381 of the head 91.

A black ink nozzle row 33 (K), a cyan ink nozzle row 33 (C), a magenta ink nozzle row 33 (M), and a yellow ink nozzle row 33 (Y) are formed in the lower surface 381 of the head 91. Each nozzle row 33 is provided with a plurality (in this embodiment, 180) of nozzles, which are ejection openings for ejecting the respective colors of ink.

The plurality of nozzles in each of the nozzle rows 33 are arranged at a constant spacing (nozzle pitch: k-D) in the paper carrying direction. Here, D is the minimum dot pitch in the paper carrying direction (that is, the spacing at the highest resolution of the dots formed on the paper). For example, if the resolution is 720 dpi, then the dot pitch is 1/720 inch (approximately 35.3 μm). Further, k is an integer of 1 or more.

The nozzles of the nozzle rows 33 are assigned numbers that become smaller toward the downstream side. Each nozzle is provided with a piezo element (not shown) as a drive element for driving the nozzle and making it eject an ink droplet.

It should be noted that during printing, the paper 7 is carried intermittently by the carry roller 37 and the paper discharge roller 39 by a predetermined carry amount F, and between these intermittent carries, the write carriage 36 is moved in the scanning direction and ink droplets are ejected from the nozzles.

<Regarding Driving of the Head>

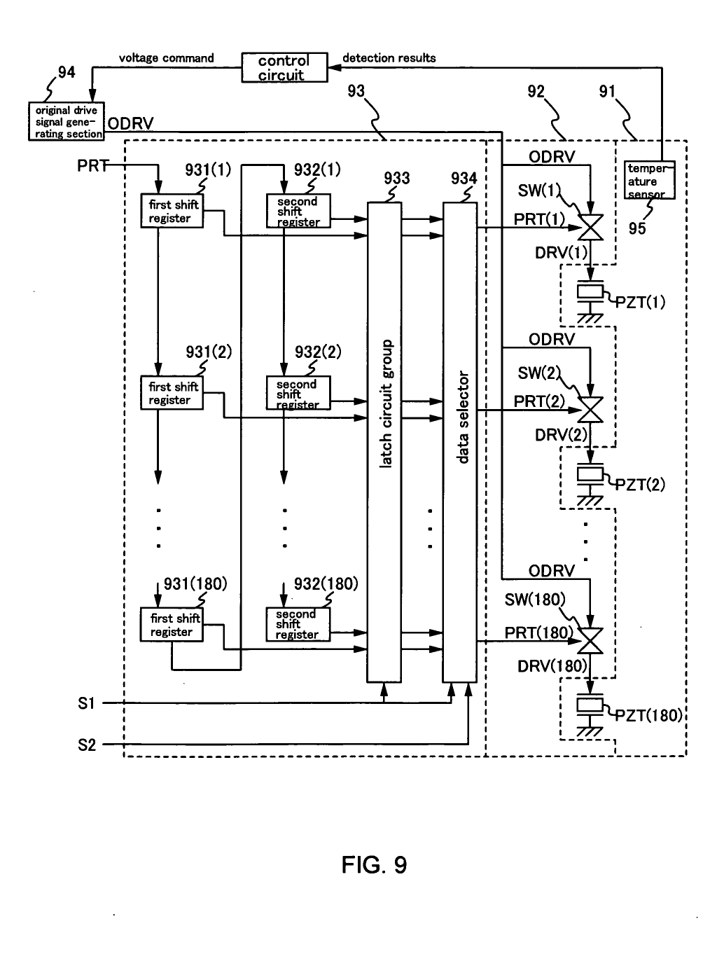

FIG. 9 is an explanatory diagram of the head unit 38. FIG. 10 is an explanatory diagram of the timing of these signals.

The head unit 38 has the head 91 as well as a switch circuit 92 and a head drive circuit 93. An original drive signal generating section 94 in the drawings is provided in a head control unit 68, which is described later. The original drive signal generating section 94, in a 20° C. environment, generates an original drive signal ODRV whose voltage amplitude is 25 v. It should be noted that the head drive circuit 93 and the original drive signal generating section 94 together make up a head drive section (head driver) for driving the head. The head 91 has nozzle rows for each color, as well as the same number of piezo elements PZT as the number of nozzles, and pressure chambers (not shown) provided within each piezo element PZT.

The head drive circuit 93 has 180 first shift registers 931, 180 second shift registers 932, a latch circuit group 933, a data selector 934, and 180 switches SW. The number in parentheses in the diagram indicates the number of the nozzle to which that member (or signal) corresponds. The head drive circuit drives the 180 piezo elements PZT based on a serially-transmitted print signal PRT such that ink droplets are ejected from the nozzles. A head drive circuit 93 is provided for each color nozzle row.

The original drive signal ODRV is a signal that is supplied in common to the 180 piezo elements. The original drive signal ODRV includes two drive pulses, namely a first pulse W1 and a second pulse W2, during the period that a nozzle crosses over the length of a single pixel. The original drive signal ODRV is transferred from the original drive signal generating section 94 provided in the main printing apparatus unit to each of the switches SW of the head drive circuit 93 via a cable.

A print signal PRT (i) is a signal corresponding to the pixel data allocated to a single pixel handled by nozzle #i. In this embodiment, the print signal PRT(i) is a signal having two bits of information per pixel. This print signal PRT(i) is transferred to the switch SW(i) from the data selector 934. The print signal PRT(i) corresponds to head drive data.

The print signals PRT are signals in which the same number of print signals PRT(i) as nozzles are serially transmitted. The print signal PRT that is serially transmitted is input to the head drive circuit 93 and converted from serial to parallel into 180 print signals PRT(i) each with two bits of data (described later).

The drive signal DRV(i) is a signal for driving the piezo element PZT(i) that is provided corresponding to the nozzle #i. When the piezo element PZT(i) receives the drive signal DRV(i), the piezo element PZT(i) is deformed according to the voltage change of the drive signal DRV(i). When the piezo element PZT(i) is deformed, the elastic film (lateral wall) partitioning a section of the pressure chamber is deformed and ink within the pressure chamber is ejected from the nozzle #i.

A first control signal S1 is input to the latch circuit group 933 and the data selector 934. A second control signal S2 is input to the data selector 934. The first control signal S1 and the second control signal S2 have pulses that indicate the timing at which the print signal PRT(i) changes.

The print signal PRT that has been serially transmitted to the head drive circuit is converted from serial to parallel into 180 print signals PRT(i) each with two bits of data as described below. First, the print signal PRT is input to the 180 pieces of first shift registers 931, and then is it input to the 180 pieces of second shift registers 932. When the pulse of the first control signal S1 is input to the latch circuit group 933, the 360 pieces of data in the shift registers are latched to the latch circuit group 933. When the pulse of the first control signal S1 is input to the latch circuit group 933, the pulse of the first control signal S1 is input to the data selector 934 as well. The data selector 934 is set to an initial state when it receives the first control signal S1. The data selector 934 in the initial state selects from the latch circuit group 933 the data that was stored in the first shift registers 931 prior to latching and outputs these to the switches SW(i) as print signals PRT(i). Then, due to the pulse of the second control signal S2, the data selector 934 selects from the latch circuit group 933 the data that was stored in the second shift registers 932 prior to latching and outputs these to the switches SW(i) as print signals PRT(i). In this manner, the print signal PRT that is serially transferred is converted into 180 pieces of two-bit data.

When the level of the print signal PRT(i) is “1”, then the switch SW(i) allows the drive pulse for the original drive signal ODRV to pass unchanged and sets it as the drive signal DRV(i). On the other hand, when the level of the print signal PRT(i) is “0”, the switch SW(i) blocks the drive pulse corresponding to the original drive signal ODRV. As a result, if the print signal PRT(i) is “11”, then the drive pulses W1 and W2 are input to the piezo element PZT(i), forming a large dot. If the print signal PRT(i) is “10”, then the drive pulse W1 is input to the piezo element PZT(i), forming a medium dot. If the print signal PRT(i) is “01”, then the drive pulse W2 is input to the piezo element PZT(i), forming a small dot. That is, a dot of a size that corresponds to the print signal PRT(i) is formed on the paper. It should be noted that if the print signal PRT(i) is “00”, then a drive pulse is not input to the piezo element PZT(i) and therefore a dot is not formed.

In this embodiment, a temperature sensor 95 is provided in the head 91. The temperature sensor 95 detects the temperature around the head 91 and outputs the results of this detection to the control circuit 50. When the temperature of the ink increases, the viscosity of the ink drops, and thus it becomes easier for the ink to be ejected from the nozzles. On the other hand, when the temperature of the ink drops, the viscosity of the ink increases, and this makes it more difficult for ink to be ejected from the nozzles. Accordingly, the control circuit 50, based on the results of the detection by the temperature sensor 95, sends a command for correcting the voltage of the original drive signal ODRV to the original drive signal generating section 94. The original drive signal generating section 94, in the case of a 30° C. environment, for example, generates an original drive signal ODRV with a 23V amplitude, and in the case of a 10° C. environment, for example, generates an original drive signal ODRV with a 27V amplitude. In this embodiment, the amplitude of the voltage of the original drive signal ODRV is altered within a range of 25V ±5V in correspondence with the temperature.

Internal Structure of the Control Circuit 50

FIG. 11 is a block diagram showing an example of the control circuit 50.

In the control circuit 50 of the SPC multifunction apparatus 1, a CPU 54 that governs the overall control of the SPC multifunction apparatus 1, a memory 55 storing a program for control, a control ASIC 51 governing control of the scanner function, the print function, and the local copy function, a SDRMA 56 to which data can be directly read and written to and from the CPU 54, and the control panel section 70, which serves as input means, are connected via a CPU bus 501. The control ASIC 51 is linked to the scanner section 10, the head unit 38, and an ASIC SDRAM 69 that is capable of reading and writing data directly to and from the control ASIC 51. The control circuit 50 is a controlling section (controller) for executing the various controls of the SPC multifunction apparatus 1.

The control ASIC 51 is provided with the scanner control unit 58, a resizing unit 59, a binarizing unit 60, an interlacing unit 62, an image buffer unit 64, a CPU interface unit (hereinafter referred to as “CPUIF unit”) 66, a head control unit 68, a USB interface (hereinafter referred to as “USBIF”) 52 serving as input/output means with respect to the external host computer 3, and a driver for the various motors and lamps, for example, of the scanner section 10 and printer section 30. Further, a line buffer 691, a resizing buffer 692, an interlace buffer 693, and an image buffer 694 are allocated within the ASIC SDRAM 69. Between the control ASIC 51 and the ASIC SDRAM 69, so-called “burst transfer” in which the data transfer unit is 64 bits is performed in order to achieve an increase in the data transfer speed. A local bus that is separate from the CPU bus 501 links the various units within the control ASIC 51.

The scanner control unit 58 controls, for example, the exposure lamp 22 of the scanner section 10, the CCD sensor 28, and a pulse motor 183 serving as the read carriage drive motor. The scanner control unit 58 has a function for sending image data that has been read via the CCD sensor 28. It should be noted that the scanner control unit 58 is capable of sending image data of a predetermined resolution by performing interpolation between pixels after the image has been read from the original document. When transmitted from the scanner control unit 58, the image data are multi-gradation RGB data (multivalue RGB data).

The resizing unit 59 has a function for receiving image data of a predetermined size and changing the size of that data and outputting the image data whose size has been changed. Here, the size of the image data is the number of pixels in the height and width of that image. The greater the number of pixels in the height and width directions, the larger the image, and the lower the number of pixels in the height and width directions, the smaller the image. However, even if the number of pixels is large, the size of the image that is actually printed may vary depending on the printing resolution. For example, even if the pixel number is the same, image data of 200 dpi×200 dpi is larger than image data of 1440 dpi×720 dpi. In other words, a change in the size of the image data is also a change in the resolution.

The binarizing unit 60 has a function for converting the multi-gradation RGB data that have been transmitted into CMYK binary data (or two-bit data) and transmitting them to the interlacing unit 62.

The interlacing unit 62 has a function for assigning CMYK data for one raster line as the data to be printed in each scan of the write carriage 36 to create data that is for overlap printing (hereinafter, referred to as “data for OL”) when performing so-called “overlap printing” in which one raster line (one line in the main-scanning direction of the print image) is printed in a plurality of scans of the write carriage 36. The data for OL that are created are stored in the interlace buffer 693 of the ASIC SDRAM 69.

Also, with the interlacing unit 62, the data stored in the interlace buffer 693 is read out to the SRAM 621 in the interlacing unit 62 in units of a predetermined size, and are rearranged on the SRAM 621 so as to correspond to the nozzle arrangement and then are transmitted to the image buffer unit 64.

The image buffer unit 64 has a function for creating head drive data for causing the nozzles in each scan of the write carriage 36 to eject ink based on the data that are transmitted from the interlacing unit 62.

The CPUIF unit 66 has a function for allowing access from the CPU 54 to the control ASIC SDRAM 69 that is connected to the control ASIC 51. In the control circuit 50, this is employed when driving the head control unit 68 based on the head drive data created by the image buffer unit 64.

The head control unit 68 has a function for driving the head unit 38 due to control by the CPU 54 so as to eject ink from the nozzles based on the head drive data.

Flow of Data Within the Control Circuit 50

<During Scanner Function>

An image read command signal for the scanner section 10 and reading information data such as the reading resolution and the reading region are sent to the control circuit 50 from the host computer 3, which is connected to the USBIF 52 of the control ASIC 51. With the control circuit 50, the scanner control unit 58 is controlled based on the image read command signal and the reading information data and starts reading of the original document 5 by the scanner section 10. At this time, the lamp drive unit, the CCD drive unit, and the read carriage scan drive unit, etc., are driven in the scanner control unit 58, and the RGB data are read from the CCD sensor 28 in a predetermined cycle. The RGB data that have been read are temporarily held in the line buffer 691 that has been allocated within the ASIC SDRAM 69 and then the R, G, and B data are each subjected to interline correction and sent to the host computer 3 via the USBIF 52. Interline correction is processing for correcting misalignment in the reading positions between the R, G, and B linear sensors that arises due to the structure of the scanner section 10. More specifically, the CCD sensor 28 of the scanner section 10 has linear sensors, which are color sensors, wherein one line of sensor is provided for each of the three colors R (red), G (green), and B (blue). These three linear sensors are arranged parallel in the scanning direction of the read carriage 16, and thus cannot simultaneously receive the reflection light that has been irradiated onto the same line of the original document 5. That is, temporal displacement occurs when the linear sensors receive the reflection light that has been irradiated onto the same line of the original document 5. Thus, this processing is for synchronizing the data, which are sent delayed by the delay amount that is a consequence of the arrangement of the linear sensors.

<During Printer Function>

During the printer function, the printer driver of the host computer 3 converts the image data into head drive data, and the head drive data are input from the USBIF 52. The head drive data, when interlacing printing is performed, for example, are data obtained by extracting the raster data corresponding to the resolution of the image to be printed and the pitch and number of the nozzles of the nozzle rows 33 in the write carriage 36, and are arranged in the order in which they are to be printed in each scan of the write carriage 36, and serve as signals for driving the head unit 38.

The head drive data are stored in the image buffer 57 that has been allocated in the SDRAM 56, which can be read directly by the CPU 54. The image buffer 57 is provided with a memory region divided into two regions (image buffers 571 and 572). Each of the image buffers 571 and 572 has a sufficient capacity to store the head drive data for printing in a single scan of the write carriage 36. Then, when data for a single scan is written to the one image buffer 571, it is transferred to the head control unit 68. At this time, when the image data of the one image buffer 571 is transferred to the head control unit 68, the head drive data for printing in the next scan is stored in the other image buffer 572. Then, when data for one scan is written to the other image buffer 572, the data is transferred to the head control unit 68 and image data is written to the one image buffer 571. In this manner, the two image buffers 571 and 572 are used to alternately read and write the head drive data while the head unit 38 is driven by the head control unit 68 to execute printing.

<During Copy Function>

The flow of data during the copy function is described next.

The data read by the scanner section 10 are sent to the line buffer 691 via the scanner control unit 58. The RGB data sent to the line buffer 691 are consecutively subjected to RGB interline correction as discussed above, and the RGB data for the same line are sent to the binarizing unit 60 from the scanner control unit 58.

The RGB data sent to the binarizing unit 60 are subjected to halftone processing and then, based on a lookup table (LUT) 696 stored in the control ASIC SDRAM 69, they are converted into binary data for each CMYK color and sent to the interlacing unit 62.

As regards the CMYK binary data that are sent to the interlacing unit 62, the whole data for each raster line are divided into the data to be printed in each scan of the write carriage 36 based on the interlacing method that has been chosen. For example, if a single raster line is to be formed in two scans of the write carriage 36, then the CMYK binary data are divided into data for forming odd-number dots and data for forming even-number dots counting from the end of the raster line, whereby the data for OL are created. The data for OL are burst transmitted to and stored in the interlace buffer 693 in units of 64 bits at a time.

Further, in the interlacing unit 62, the data stored in the interlace buffer 693 are read out in units of a predetermined size and burst transmitted to the SRAM 621 in the interlacing unit 62. At this time, the data for OL are read out from the interlace buffer 693 in correspondence with the nozzle arrangement of the head 91 based on the resolution of the image to be printed and the nozzle pitch. For example, if the resolution of the image to be printed is 720 dpi and the nozzle pitch is 1/180 inch, then there will be three raster lines between two raster lines that are printed by adjacent nozzles. Thus, data with a three-raster line interval are read out from the data for OL as data corresponding to the scanning of the write carriage 36.

The transferred data are rearranged on the SRAM 621 such that they correspond to the nozzle arrangement, and are then sent to the image buffer unit 64.

In the image buffer unit 64, image data provided as even smaller blocks due to the capacity of the SRAM 621 are burst transferred to the image buffer 694 and stored arranged in rows such that they become head drive data for causing the nozzles in each scan of the write carriage 36 to eject ink. Here, image buffers 694 and 695 have been allocated as memory regions for storing two scans of the write carriage 36 worth of head drive data, and each time head drive data for one scan has accumulated, the data is sent to the head control unit 68 by the CPU 54, and writing of the head drive data corresponding to the next scan to the remaining memory region for one scan is begun. This processing is the same as the processing with the image buffers that was discussed above in the description of the printer function.

The head drive data for each scan stored in the image buffers 694 and 695 are read into to the CPU 54 via the CPUIF unit 66 under the control of the CPU 54, and then transferred to the head control unit 68 by the CPU 54. The head control unit 68 drives the head unit 38 according to the head drive data, thereby printing an image.

In the normal copy operation, layout processing requiring computing by the CPU 54 is not performed during the period from when the RGB image data are read by the scanner control unit 58 until when the CMYK head drive data are written to the image buffers 694 and 695. In other words, the process of converting RGB image data to CMYK head drive data does not require the CPU 54 and is executed centrally in the control ASIC. Thus, during this process, it is not necessary to send and receive data between the SDRAM for the ASIC and the SDRAM for the CPU. That is, data are transmitted between the control ASIC 51 and the ASIC SDRAM 69 using only the local bus 511, and thus the CPU bus 501 is hardly used. Therefore, the processing is faster, allowing the copy speed to be increased.

Correction Process

In the present embodiment, when the processing for correcting the various setting values is begun, the SPC multifunction apparatus 1 prints a test pattern for correction of the various setting values, such as the ink ejection amount or the bidirectional printing position. Then, the SPC multifunction apparatus reads the test paper on which the test pattern has been printed using the scanner section 10 and corrects the various setting values based on the results of that reading.

There are two types of methods for starting the correction process.

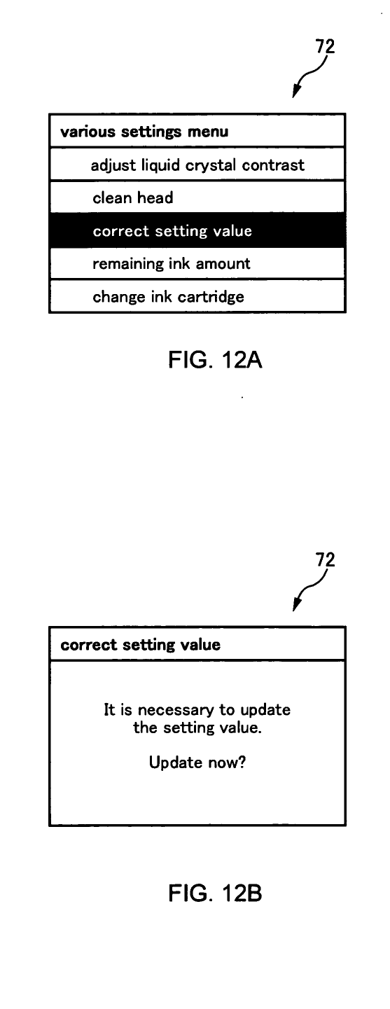

A first method is a method in which the user operates the control panel section 70 to start the correction process. When the various settings button 76 of the control panel section 70 is pressed, a screen for changing the various settings of the SPC multifunction apparatus 1 is displayed on the liquid crystal display 72. FIG. 12A shows the various settings menu screen that is displayed on the liquid crystal display 72. The user, by selectively pressing the multidirectional button 87 up and down, can move the inverted display field up and down. In the diagram the field “setting value correction” is shown in inverted display. When the OK button 81 is pressed in this state, the process for correcting the setting value is started.

The second method is a method in which the SPC multifunction apparatus itself determines when the correction process is necessary. In this case, the control circuit 50 is provided with a counter (not shown). The counter increases a count value in an increment of one each time the printer section 30 prints a sheet of paper. Then, when the CPU 54 detects that the count value has arrived at a predetermined value, the CPU 54 displays, on the control panel section 70, a screen urging the user to perform correction of the setting value. FIG. 12B shows the screen that is displayed at this time. When the OK button 81 is pressed in this state, the process for correcting the setting value is started.

It should be noted that there is no limitation to counting the number of printed sheets, and it is also possible for the number of times ink is ejected by the head to be counted. In this case, when the head drive data is transferred to the head control unit 68, the CPU 54 analyzes the head drive data and counts the number of ink ejections by the head.

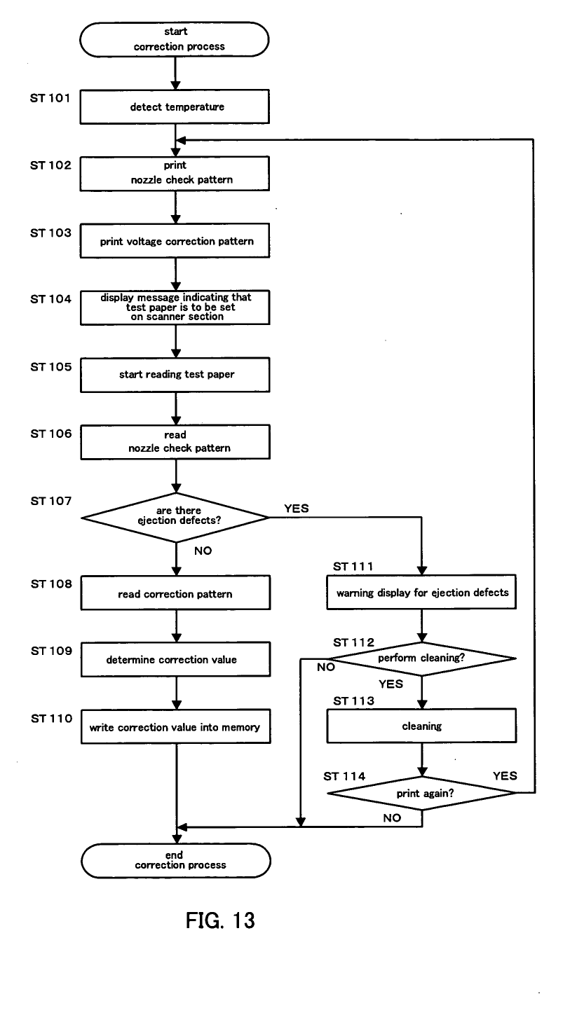

FIG. 13 is a flowchart of the correction process according to the present embodiment. The following processes are achieved by the control circuit 50 controlling the various units in accordance with a program stored in the memory 55 of the SPC multifunction apparatus.

<ST101: Temperature Detection>

First, the temperature sensor detects the temperature around the head (ST101). The control circuit 50 corrects the voltage of the original drive signal ODRV based on the output value of the temperature sensor.

<ST102: Print the Nozzle Check Pattern>

Next, the printer section 30 prints a nozzle check pattern (ST102).

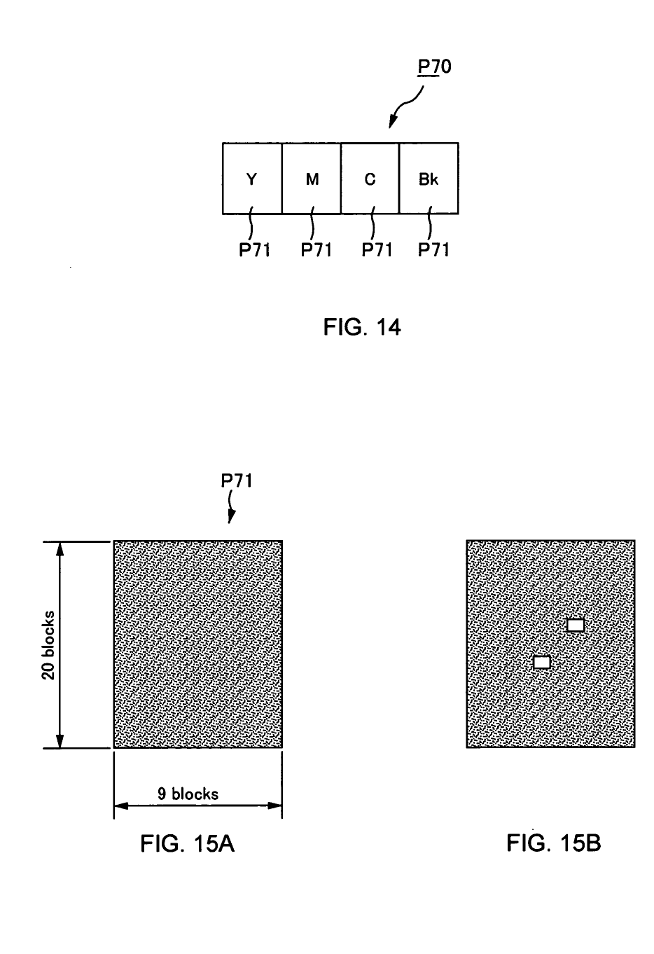

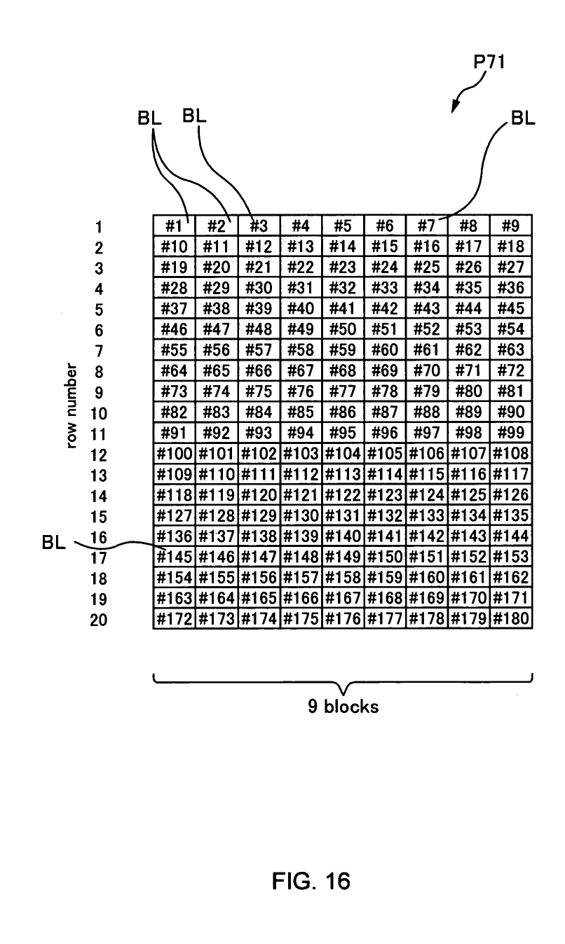

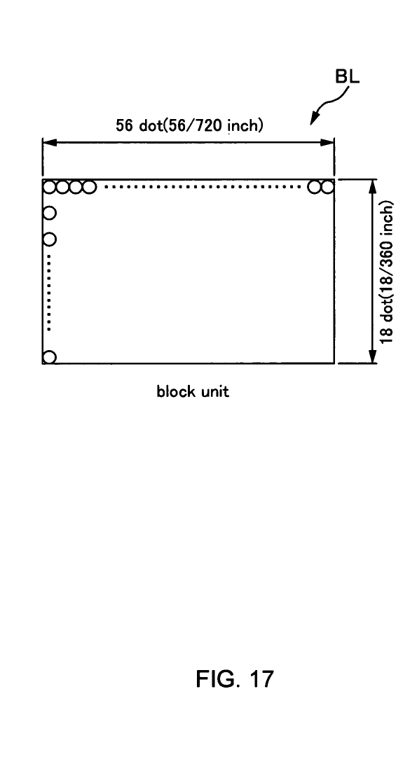

FIG. 14 is a conceptual diagram that shows an entire nozzle check pattern group P70 used for checking nozzle ejection. FIG. 15A is an explanatory diagram of one nozzle check pattern P71 that makes up the nozzle check pattern group P70. FIG. 15B is an example of a nozzle check pattern in a case where there are nozzles that do not eject ink (in the case of ejection defects). FIG. 16 is an explanatory diagram showing the configuration of one nozzle check pattern P71. FIG. 17 is an explanatory diagram of one block pattern BL making up the nozzle check pattern P71.

The nozzle check pattern group P70 is made of a plurality of nozzle check patterns P71. The plurality of nozzle check patterns P71 are formed adjacent to one another in the scanning direction. The nozzle check patterns are formed separately for the different ink colors. For example, the nozzle check pattern P71 in which “Y” is written in FIG. 14 is made of only yellow ink. In other words, the nozzle check pattern P71 in which “Y” is written is formed by the nozzles that eject yellow ink. As discussed later, this nozzle check pattern P71 is used for checking ejection of the nozzles for ejecting yellow ink. The nozzle check patterns P71 for the other colors are configured in the same manner.

A single nozzle check pattern P71 is made of a total of 180 block patterns BL—nine block patterns BL arranged in the scanning direction and 20 block patterns BL arranged in the carrying direction. A single block pattern BL corresponds to a single nozzle. Thus, the 180 block patterns BL are patterns for checking each of the 180 nozzles.

Each block pattern BL is a rectangular pattern made of 56 dots at a 1/720 inch interval in the scanning direction and 18 dots at a 1/360 inch interval in the carrying direction. The dots within a same block pattern BL are formed by ink droplets ejected from the same nozzle. For example, the block pattern BL designated as “#1” in FIG. 16 is formed only by ink droplets ejected from the nozzle #1. Thus, each block pattern BL is associated with the nozzle for forming that block pattern BL. If there is an ink non-ejecting nozzle (a nozzle that does not eject ink), then, as shown in FIG. 15B, a rectangular blank pattern results in the nozzle check pattern P71. That is, by detecting whether or not there are blank patterns, it is possible to check whether or not there are ink non-ejecting nozzles (i.e., it is possible to detect clogging of a nozzle). It should be noted that if the position of a blank pattern can be detected, then the ink non-ejecting nozzle can be specified as well.

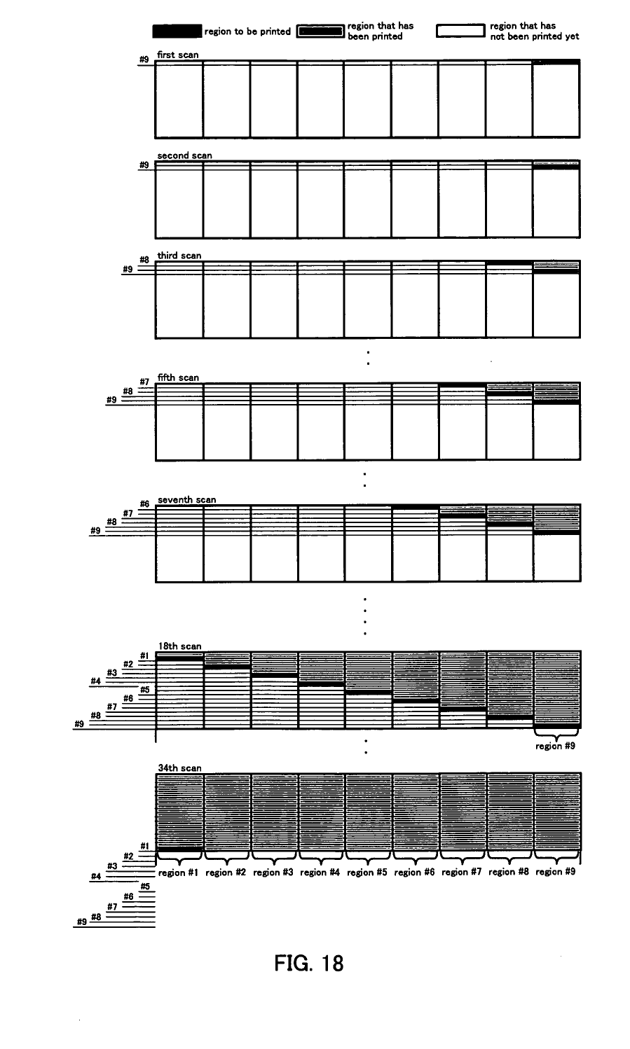

FIG. 18 is an explanatory diagram of the method for forming the nine block patterns in the first row of the nozzle check pattern P71. The diagram shows the dot rows (56 dot rows lined up in the scanning direction of FIG. 17) that are formed by a single dot formation process (the process of ejecting ink from the head during movement of the carriage). Also, the numbers on the left side of the diagram indicate the nozzle numbers, and the position of the nozzle numbers indicates the position of the nozzles with respect to the block pattern BL.

First, the print paper is fed until the front end position, on the carrying direction downstream side, of the block pattern BL is in opposition to the nozzle #9. Then, the printer executes a first dot formation process, and when the carriage 36 is positioned at a predetermined position, ink is ejected intermittently from nozzle #9. Thus, a dot row is formed at a position on the downstream side of the block pattern corresponding to nozzle #9.

Next, the printer carries the paper by half of the nozzle pitch (1/360 inch) using the carrying unit. Then, the printer executes a second dot formation process, and when the carriage arrives at a predetermined position, ink is ejected intermittently from nozzle #9. Thus, a dot row is formed adjacent, on the carrying direction upstream side, to the dot row formed in the first dot formation process.

Next, the printer carries the paper by half of the nozzle pitch using the carrying unit. Then, the printer executes a third dot formation process. In the third dot formation process, the printer intermittently ejects ink from nozzle #9 and nozzle #8. A dot row is formed by the ink ejected from nozzle #9 adjacent, on the carrying direction upstream side, to the dot row formed in the second dot formation process. Also, a dot row is formed by the ink that is ejected from nozzle #8 at a position on the downstream side of the block pattern BL corresponding to nozzle #8.

Next, the printer carries the paper by half of the nozzle pitch using the carrying unit. Then, the printer executes a fourth dot formation process. In the fourth dot formation process as well, the printer intermittently ejects ink from nozzle #9 and nozzle #8, forming dot rows adjacent, on the carrying direction upstream side, to the dot rows formed in the third dot formation process. In this manner, dot rows are formed twice by executing dot formation and carrying, and per every two dot-formation processes, the number of nozzles ejecting ink is increased by one from the carrying direction upstream side.

In the 18th dot formation process, the block pattern corresponding to nozzle #9 is completed. Thus, in the 19th dot formation process, the ejection of ink from nozzle #9 is stopped. Thereafter, per every two dot-formation processes, the ejection of ink is stopped one nozzle at a time in order from the nozzle positioned upstream in the carrying direction.

Then, in the 34th dot formation process, the nine block patterns of the first row are completed.

The above description was for a method for forming the nine block patterns of the first row, which is positioned on the most downstream side in the carrying direction of the nozzle check pattern P71, but the nine block patterns of the other rows are formed simultaneously while the nine block patterns of the first row are being formed. That is, the 180 nozzles from nozzle #1 to nozzle #180 are grouped into 20 nozzle groups of nine consecutive nozzles per group, and nine block patterns are formed by each nozzle group using the same procedure. For example, when a dot row is being formed by nozzle #9, ink is being ejected at the same timing from nozzle #9N (where N is an integer).

<ST103: Printing a Voltage Correction Pattern>

Next, the printer section 30 prints a voltage correction pattern (ST102).

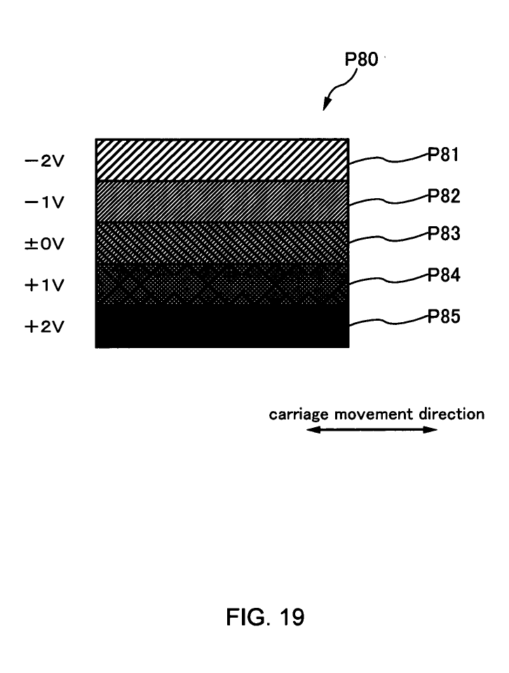

FIG. 19 is an explanatory diagram for the voltage correction pattern. A voltage correction pattern P80 is made of a plurality of band patterns P81 to P85. These plurality of band patterns are formed lined up in the carrying direction. The band patterns are rectangular patterns that are elongated in the scanning direction. It should be noted that the voltage correction pattern is formed on the same paper as the paper on which the nozzle check patterns mentioned above are formed.

The band patterns are formed in accordance with pattern data of the same gradation value. However, the voltage of the original drive signal ODRV when forming the band patterns is different. Thus, the size of the ink droplets that are ejected when forming the band patterns is different, leading to different size dots making up the band patterns. For this reason, the darkness of the band patterns that are formed is different. Also, because band patterns with different darkness are formed in a line, the voltage correction pattern P80 is structured such that it is provided with gradations.

First, the printer section 30 creates an original drive signal ODRV whose voltage value is 2V lower than the voltage of the original drive signal ODRV that was corrected in ST101, and forms a band pattern P81 using this original drive signal ODRV while moving the carriage in the scanning direction. Because an original drive signal ODRV with a relatively low voltage is used, the expansion and constriction of the piezo elements is small and relatively small ink droplets are ejected, such that the band pattern P81 is a relatively light pattern.

After the band pattern P81 has been formed, the carrying mechanism carries the paper in the carrying direction. Then, the printer section 30 creates an original drive signal ODRV whose voltage value is 1V lower than the voltage of the original drive signal ODRV that was corrected in ST101, and forms a band pattern P82 using this original drive signal ODRV while moving the carriage in the scanning direction.

In this manner, the voltage is changed 1V at a time with respect to the voltage of the original drive signal ODRV that was corrected in ST101 while forming the band patterns P81 to P85. It should be noted that the band pattern P83 is formed at the same voltage as that of the original drive signal ODRV corrected in ST101. Also, an original drive signal ODRV with a relatively high voltage is used for the band pattern P85, and thus there is a large expansion and constriction of the piezo elements and relatively large ink droplets are ejected, such that the band pattern P85 is a relatively dark pattern.

It should be noted that after the voltage correction pattern P80 has been printed, the control circuit 50 begins measuring the time using a timer. The reason being this is described later.

<ST104: Setting the Test Paper>

Next, the liquid crystal display 72 performs a display prompting setting, on the scanner section 10, of the test paper on which the nozzle check pattern P70 and the voltage correction pattern P80 have been printed.

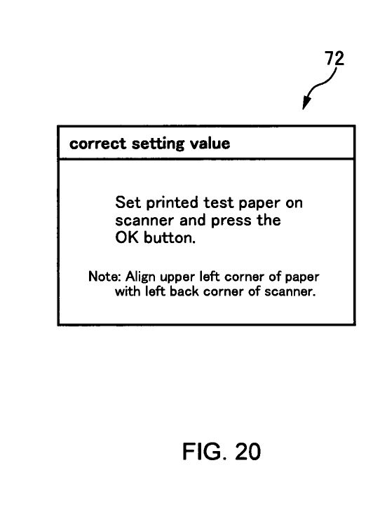

FIG. 20 is a screen displayed on the liquid crystal display 72 when the test paper is to be set. This screen includes a display urging the user to set the test paper as well as a display indicating the direction in which the test paper is to be set.

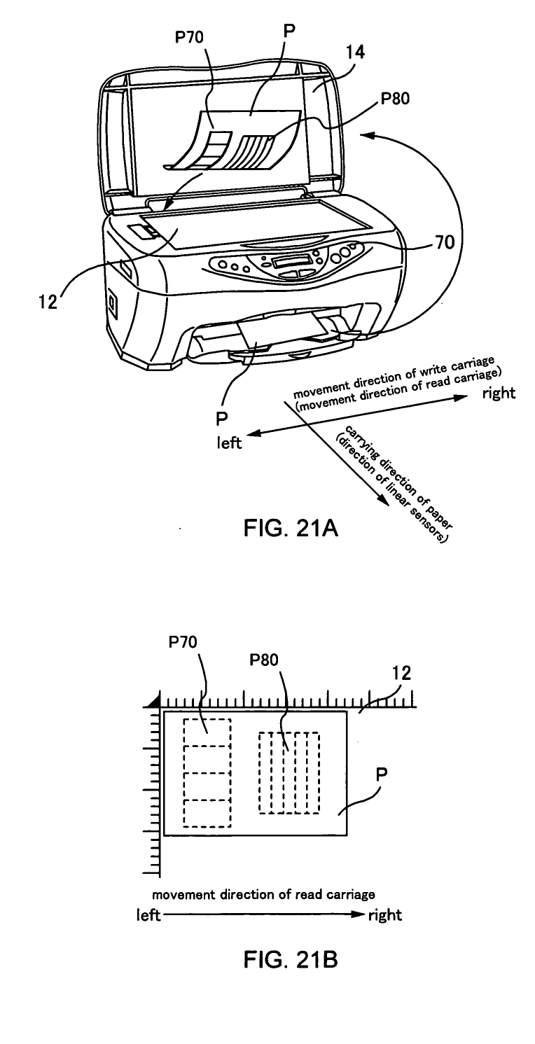

FIG. 21A is an explanatory diagram showing how the test paper is to be set on the SPC multifunction apparatus 1. FIG. 21B is an explanatory diagram of the test paper placed on the original bed glass 21 of the scanner section 10.

When the user sets the test paper aligning the upper left of the paper with the left back corner of the scanner in accordance with the display screen, the test paper is set such that the nozzle check pattern P70 of the test paper is positioned more on the left side than the voltage correction pattern P80. After the paper has been set on the scanner section 10, the user presses the OK button 81 in accordance with the instructions on the display screen.

<ST105: Start Reading the Test Paper>

When the OK button 81 has been pressed, the scanner section 10 starts reading the test paper.

Before starting reading the test paper, the read carriage 16 is put into standby at a position on the left end in FIG. 21B. Then, when the scanner section 10 starts reading the test paper, the read carriage 16 moves from left to right in FIG. 21B.

If the user has set the test paper in accordance with the display screen mentioned above, then the test paper has been set such that the nozzle check pattern P70 is positioned more on the left side than the voltage correction pattern P80, and thus the scanner section 10 reads the nozzle check pattern P70 before it reads the voltage correction pattern P80.

<ST106, ST107: Checking the Nozzles>

First, the nozzle check pattern P70 is read by the scanner section 10. The scanner section 10 outputs the RGB data read by the CCD sensor 28 to the scanner control unit 58. The scanner control unit 58 temporarily holds the RGB data that has been read in the line buffer and then subjects the R, G, and B data each to interline correction, after which it stores the RGB data in the SDRAM 56 via the CPUIF unit 66. The CPU 54 analyzes the RGB data stored in the SDRAM 56, thereby checking the nozzles.

If the CPU 54 does not detect a blank pattern among the RGB data, then there are no non-ejecting nozzles from which ink is not ejected, and thus the CPU 54 determines that there are no ejection defects (NO in ST107). On the other hand, if the CPU 54 detects blank patterns such as those in FIG. 15B from among the RGB data, then there are non-ejecting nozzle from which ink is not ejected, and the CPU 54 therefore determines that there are ejection defects (YES in ST107).

<ST108: Reading the Voltage Correction Pattern>

If there are no ejection defects (NO in ST107), then the voltage correction pattern P80 is read. The RGB data read by the scanner section 10 are stored on the SDRAM 56 in the same way as with the nozzle check pattern. The CPU 54 analyzes the RGB data stored in the SDRAM 56 and detects the gradation values of the band patterns of the voltage correction pattern P80.

A predetermined gradation value is stored in the memory 55 in advance as a threshold value. The gradation value serving as the threshold value is the same as the gradation value of the pattern data when the band patterns are formed.

If the head ejecting the ink forms the band patterns under ideal conditions, then the gradation value obtained by reading the band pattern P83 that is formed without correcting the voltage of the original drive signal ODRV should be equal to the gradation value of the pattern data for forming the band pattern P83. However, because of changes in the piezoelectric elements over time or manufacturing discrepancies, for example, it is rare that ink is ejected from the head under ideal conditions. Thus, the gradation value obtained by reading the band pattern P83 does not necessarily match the threshold value. In this embodiment, it is assumed that the gradation value obtained by reading the band pattern P84 that is formed after correcting the voltage of the original drive signal ODRV by +1V matches the threshold value.

Incidentally, if little time has elapsed after the voltage correction pattern is formed on the paper, then the darkness of the voltage correction pattern is not stable. For this reason, when reading the voltage correction pattern, the gradation values obtained by reading differ depending on the amount of elapsed time since the voltage correction pattern was formed. For example, there is a possibility that, although the gradation value that is obtained by reading the voltage correction pattern 30 seconds after it has been formed may be 130, the gradation value that is obtained by reading once the darkness has stabilized may be 135.

Accordingly, in the present embodiment, the time that has passed since printing the voltage correction pattern is measured with a timer. There are two conceivable methods in which this timer may be employed.

The first usage method is a method in which the gradation value that is obtained by reading is corrected in accordance with the amount of elapsed time after the voltage correction pattern is formed. For example, if the gradation value that is obtained by reading is 130 and the amount of time measured by the timer is 30 seconds, then the gradation value is corrected to 135. In this case, a table indicating the relationship between the elapsed time and the correction value is stored on the memory 55.

The second usage method is a method in which reading of the voltage correction pattern is put on standby until the darkness of the correction pattern has become stable. There are two possible approaches with this method. The first is to hold off displaying the screen of FIG. 20 until a time at which the darkness of the correction pattern becomes stable has passed. For example, if the darkness of the voltage correction pattern becomes stable 10 minutes after printing, then the screen of FIG. 20 is displayed when the time measured by the timer reaches ten minutes. The other approach is to hold off reading the voltage correction pattern until a time at which the darkness of the correction pattern becomes stable passes after the test paper is set on the scanner section and the OK button is pressed (that is, the scanner section 10 is not moved immediately after the OK button is pressed but rather the scanner section 10 is automatically moved when the time measured by the timer has reached a predetermined time). With the latter approach, the user does not have to wait in front of the SPC multifunction apparatus when setting the test paper on the scanner section, and thus compared to the former approach, there is less burden on the user. Also, with these approaches it is possible to obtain a gradation value that is more reliable than in the above-mentioned case in which the gradation value that is obtained by reading is corrected.

<ST109, ST110: Setting and Writing the Correction Value>

In the present embodiment, the CPU 54 determines that the gradation value obtained by reading the band pattern P84 matches the threshold value. Thus, the CPU 54 sets the correction value to “1” and then stores the data corresponding to “+1” on the memory 55.

Thus, when the user executes printing using the SPC multifunction apparatus 1, the voltage of the original drive signal ODRV is further corrected to +1V of the voltage of the original drive signal ODRV that has been set according to the detection results of the temperature sensor.

<ST111 to ST114: Warning Display, Cleaning>

If there are ejection defects (YES in ST107), then the voltage correction pattern P80 is not printed correctly and thus the SPC multifunction apparatus 1 stops reading of the test paper and performs a display on the liquid crystal display 72 warning that there are ejection defects.

This warning screen (not shown) includes a message urging the user to perform cleaning. Cleaning is then started when the OK button 81 is pressed (YES in ST112).

Examples of the cleaning process include a flushing process and a sucking process. The flushing process is a process in which the head is forcibly driven to forcibly eject ink from nozzles (idle ejection) and thereby fix clogged nozzles. The sucking process is a process in which the outside of the nozzles is set to a negative pressure to suck out the ink within the nozzles and thereby fix clogged nozzles. Both processes consume ink, and thus there are instances in which the user may consider cleaning undesirable. For that reason, the correction process is ended if the user presses the cancel button 82 when the warning screen is displayed (NO in ST112).

A screen urging the user to perform printing again is displayed after cleaning has finished. When the OK button 81 is pressed (YES in ST114), the printer section 10 reprints the nozzle check pattern and the voltage correction pattern. On the other hand, when the cancel button 82 is pressed (NO in ST 114), the correction process is ended without performing printing again.

With the SPC multifunction apparatus of the present embodiment described above, the control circuit 50 causes the head drive section, which is made of the head drive circuit 93 and the original drive circuit generation section 94, to form the voltage correction pattern P80 and causes the scanner section 10 to read the voltage correction pattern P80, and based on the results of this reading, corrects the voltage of the original drive signal ODRV that is generated by the original drive signal generating section 94. Thus, if correction is performed by the SPC multifunction apparatus, in which the printer section and the scanner section are formed as a single unit, the number of processes for the user to perform is reduced, and this is convenient.

In the present embodiment, the control circuit 50 causes the printer section 30 to first print the nozzle check pattern P70 and then to print the voltage correction pattern P80. Then, the control circuit 50 causes the scanner section 10 to check the nozzle check pattern P70 before it checks the voltage correction pattern P80. This is because the voltage correction pattern P80 is printed light if there are nozzles with ejection defects, making it impossible to properly carry out voltage correction. In the present embodiment, reading of the voltage correction pattern P80 is cancelled if there are nozzles with ejection defects, and thus unnecessary processing is eliminated.

In the present embodiment, for the sake of convenience of the user, once the test paper has been printed, the control circuit 50 makes the liquid crystal display 72 of the control panel section 70 perform a display indicating that the test paper is to be set on the scanner section 10. Moreover, in this embodiment the liquid crystal display 72 performs a display that instructs the user on how to orient the paper to be set. If the user sets the test paper on the scanner section 10 according to this instruction, then the scanner section 10 can check the nozzle check pattern P70 before the voltage correction pattern P80.

In the present invention, the control circuit 50 causes the printer section to form the voltage correction pattern P80. However, this is not a limitation. For example, this pattern may alternatively be a correction pattern for correcting the dot formation positions (ink ejection timing) when performing bidirectional printing.

In the present embodiment, the control circuit 50 corrects the voltage of the original drive signal ODRV based on the detection results of the temperature sensor 50, and then causes the printer section 30 to form a voltage correction pattern according to the original drive signal ODRV at the corrected voltage. For example, in the case of a 30° C. environment, the control circuit 50 corrects the amplitude of the voltage of the original drive signal ODRV from 25V to 23V, and causes the printer section 30 to form the voltage correction pattern P80 at the 23V original drive signal ODRV. Then, when the band pattern P84, whose voltage correction amount is “+1,” is selected, the control circuit 50 further corrects the voltage of the original drive signal ODRV by +1V, setting it to 24V. Thereafter, when the environment becomes 20° C., the amplitude of the voltage of the original drive signal ODRV is set to 26V, and when the environment becomes 10° C., the amplitude of the voltage of the original drive signal ODRV is set to 28V. Thus, in the present embodiment, it is possible to distinctly make corrections of the voltage in response to temperature changes and corrections of the voltage in response to changes in the piezo elements over time, for example.

1. A printing apparatus comprising:
a head driver for driving a head that ejects ink;
a scanner for reading an image formed on a medium; and
a controller for controlling said head driver to form a correction pattern on said medium, causing said scanner to read said correction pattern that has been formed on said medium, and correcting driving of said head by said head driver based on the results of reading said correction pattern.

2. A printing apparatus according to claim 1, wherein
said controller controls said head driver to form on said medium a check pattern for detecting clogging of said nozzles, causes said scanner to read said check pattern that has been formed on said medium, and detects clogging of said nozzles based on the results of reading said check pattern.

3. A printing apparatus according to claim 2, wherein
said controller detects clogging of said nozzles based on said check pattern before correcting driving of said head based on said correction pattern.

4. A printing apparatus according to claim 3, wherein
said scanner does not read said correction pattern if said controller has detected that there is a clogged nozzle.

5. A printing apparatus according to claim 1, further comprising:
a display section for performing a display indicating that said medium is to be set on said scanner after said correction pattern has been formed on said medium.

6. A printing apparatus according to claim 1, wherein
said controller:
controls said head driver to form said correction pattern and a different pattern that is different from said correction pattern on said medium;
causes said scanner to read said different pattern that has been formed on said medium; and
controls reading of said correction pattern based on the results of reading said different pattern.

7. A printing apparatus according to claim 6, further comprising:
a display section;
wherein said scanner is for reading images formed on said medium from a predetermined direction; and
wherein after said correction pattern has been formed on said medium, said display section performs a display indicating that said medium is to be set on said scanner such that said different pattern is read by said scanner before said correction pattern.

8. A printing apparatus according to claim 7, wherein
said different pattern is a check pattern for detecting clogging of said nozzles.

9. A printing apparatus according to claim 8, wherein
said scanner does not read said correction pattern if said controller has detected that there is a clogged nozzle.

10. A printing apparatus according to claim 1, wherein:
said head driver gives a drive signal to a drive element to drive said head; and
said controller corrects a voltage of said drive signal based on the results of reading said correction pattern.

11. A printing apparatus according to claim 10, further comprising:
a temperature sensor for detecting a temperature;
wherein said controller corrects a voltage of said drive signal based on the detection results of said temperature sensor.

12. A printing apparatus according to claim 11, wherein
said controller causes said head driver to form said correction pattern in accordance with said drive signal of a voltage that has been corrected based on the detection results of said temperature sensor.

13. A printing apparatus according to claim 10, further comprising:
a timer for measuring an amount of time that has passed since said correction pattern has been formed.

14. A printing apparatus according to claim 13, wherein
said controller corrects said results of reading according to the measured time that is measured by said timer.

15. A printing apparatus according to claim 13, wherein
said controller puts reading of said correction pattern on standby until the measured time that is measured by said timer reaches a predetermined time.

16. A printing apparatus according to claim 1, further comprising:
a display section;
wherein said controller:
counts a number of printed sheets; and
performs a display urging correction when said number of printed sheets that has been counted reaches a predetermined number.

17. A printing apparatus according to claim 1, further comprising:
a display section;
wherein said controller:
counts a number of times of ejections of ink by said head; and
performs a display urging correction when said number of times of ejections that has been counted reaches a predetermined number.

18. A printing apparatus comprising:
a head driver for driving a head that ejects ink;
a scanner for reading an image formed on a medium;
a controller for controlling said head driver to form a correction pattern on said medium, causing said scanner to read said correction pattern that has been formed on said medium, and correcting driving of said head by said head driver based on the results of reading said correction pattern; and
a display section for performing a display indicating that said medium is to be set on said scanner after said correction pattern has been formed on said medium;
wherein said controller:
controls said head driver to form said correction pattern and a different pattern that is different from said correction pattern on said medium;
causes said scanner to read said different pattern that has been formed on said medium; and
controls reading of said correction pattern based on the results of reading said different pattern;
wherein said scanner is for reading images formed on said medium from a predetermined direction;
wherein after said correction pattern has been formed on said medium, said display section performs a display indicating that said medium is to be set on said scanner such that said different pattern is read by said scanner before said correction pattern;
wherein said different pattern is a check pattern for detecting clogging of said nozzles;
wherein said scanner does not read said correction pattern if said controller has detected that there is a clogged nozzle;
wherein said head driver gives a drive signal to a drive element to drive said head;
wherein said controller corrects a voltage of said drive signal based on the results of reading said correction pattern;
wherein said printing apparatus further comprises a temperature sensor for detecting a temperature;
wherein said controller corrects a voltage of said drive signal based on the detection results of said temperature sensor;
wherein said controller causes said head driver to form said correction pattern in accordance with said drive signal of a voltage that has been corrected based on the detection results of said temperature sensor;
wherein said printing apparatus further comprises a timer for measuring an amount of time that has passed since said correction pattern has been formed;
wherein said controller puts reading of said correction pattern on standby until the measured time that is measured by said timer reaches a predetermined time; and
wherein said controller:
counts a number of printed sheets; and
performs a display urging correction when said number of printed sheets that has been counted reaches a predetermined number.

19. A method for adjusting a printing apparatus comprising a head driver for driving a head that ejects ink and a scanner for reading an image formed on a medium, said method comprising:
forming a correction pattern on said medium with said head driver;
reading said correction pattern with said scanner; and
correcting driving of said head by said head driver based on the results of reading said correction pattern.
